(19) United States
(12) Patent Application Publication
(10) Pub. No.: US 2012/0281242 A1
(43) Pub. Date: Nov. 8, 2012

(54) Image Forming Apparatus, Image Repeat Method and Layout Method of Image Forming Apparatus, Programs of Image Repeat Method and Layout Method, and Storage Medium Storing Programs

(75) Inventor: Hidehiko Asai, Kanagawa (JP)

(73) Assignee: CANON KABUSHIKI KAISHA, Tokyo (JP)

(21) Appl. No.: 13/549,793

(22) Filed: Jul. 16, 2012

Related U.S. Application Data
(63) Continuation of application No. 10/762,342, filed on Jan. 23, 2004.

(30) Foreign Application Priority Data
Jan. 24, 2003 (JP) 2003-015667
Jan. 7, 2004 (JP) 2004-002171

(51) Int. Cl. G06K 15/00

(52) U.S. Cl. 358/1.6

(57) ABSTRACT

To provide flexible image repeat environments coping with user's needs for using an image repeat function to obtain an image considering a cutout operation and for using this function to obtain background and pattern, an image forming apparatus includes, in the image repeat function, a first layout mode that the adjacent same data on the same face of one paper are arranged with intervals added in the first and second directions, and a second layout mode that the adjacent same data on the same face of the one paper are arranged without intervals in the first and second directions, and comprises a selector for selecting the first or second layout mode in the image repeat function, and a controller for causing to execute the first and second layout modes in the image repeat function respectively when the first and second layout modes are selected.

### BACKGROUND OF THE INVENTION

1. Field of the Invention

The present invention relates to an image repeat function by which a part of image or an entire image is formed as plural images on one recording medium.

2. Related Background Art

In recent years, an image repeat function to form a part of image or an entire image on one recording medium as plural images (that is, plural same or identical images are printed on the same face of one recording paper) has been developed in a digital copying machine. Such an image repeat function is frequently used to form a background, a pattern and the like of an advertising material and the like mainly in design business, advertising business and the like. In this case, the plural same images are closed up and thus printed as a one-face image.

Incidentally, in recent years, the image repeat function is used to generate plural same printed materials which are obtained by cutting out the one-face image including the plural images disposed to be closed up. For example, the image repeat function is used when tickets are made. In such a case, each of the plural same images formed by closing up the images on a recording paper with the use of the image repeat function is finally used as a separate output material (i.e., ticket). Thus, an operator has to cut out each image manually or by using a cutting machine. For this reason, to generate quite the same printed materials by cutting out each of the images of the one face of the recording paper on which the plural images are disposed to be closed up (that is, to handle each of the images of the one face of the recording paper as the separate output material), it is necessary to strictly adjust the cutting position of each image.

As just described, it is assumed that the plural same images are formed on the same face of the recording paper by effectively using the image repeat function, and the one printed recording paper is cut by the operator with respect to each of the plural same images printed on the one face thereof. In such a case, it is necessary for the operator to take particular care to cut the printed recording paper cautiously so that a partial lost portion or the like of the image does not occur.

The digital copying machine generally contains plural paper feed stages, whereby the horizontal positions and the paper stacking positions of these paper feed stages might shift slightly. In such a case, it is expected that it is highly difficult to print the images at quite the same position on the recording papers fed from all the paper feed stages due to position shift, oblique feed and the like caused by the transportation of the recording papers in the copying machine. Therefore, when it aims to cut out each of the plural same images printed on the recording paper, it is necessary to strictly and accurately adjust the digital copying machine so that all the output images are printed to the corresponding same positions on the recording papers.

Moreover, when it is bear in mind that also environments such as humidity, temperature and the like in which the recording papers are set cause the position shift, the oblique feed and the like, it is necessary to take care of these environments. However, it is practically difficult for general users to always take into account and adjust the state and the environment of the digital copying machine.

As just described, in a case where the image forming apparatus and the environment thereof are not correctly adjusted and controlled, there is a possibility that the image print position of each recording paper slightly shifts from others. Therefore, to absorb the shift of the image print position of each recording paper, it is necessary for the operator to adjust the cut-out positions of all the recording papers, whereby it becomes highly complicated to generate the plural same outputs.

### SUMMARY OF THE INVENTION

An object of the present invention is to provide an image forming apparatus which can solve the above problem, an image repeat method and a layout method for the image forming apparatus, programs of the image repeat method and the layout method, and a storage medium for storing the programs.

Another object of the present invention is to provide an image forming apparatus that a margin adding function to add a margin between adjacent two of plural formed images is provided in an image repeat process which repeatedly forms a part or all of image data on one recording paper plural times, a user who intends to cut out the recording paper on which the image repeat images have been formed can cut out the recording paper along the margin acting as the cutout margin between the repeated images, it is thus possible to make image shift or aberration in the image cutout operation due to some image shift or aberration in a printing operation obscure, thereby easily satisfying user's needs in the image cutout operation without considering device adjustments, environments and the like, and that a setting function to enable the user to select and set whether or not to use the margin adding function is provided, and it is possible by controlling whether or not to add the margin based on the set result to easily satisfy user's needs concerning the output result in which the intervals between the adjacent images are closed up, thereby providing flexible image repeat environments of satisfying the conventional and new user's needs; an image repeat method and a layout method for the image forming apparatus; programs of the image repeat method and the layout method; and a storage medium for storing the programs.

A still another object of the present invention is to provide an image forming apparatus that it is possible to provide flexible image repeat environments capable of coping with the above various user's needs in consideration of operability, usability for the user, and the like; an image repeat method and a layout method for the image forming apparatus; programs of the image repeat method and the layout method; and a storage medium for storing the programs.

Other objects and features of the present invention will be apparent from the following description taken in conjunction with the accompanying drawings.

### BRIEF DESCRIPTION OF THE DRAWINGS

FIG. 1 is a cross section diagram showing an example of a copying machine to which an image forming apparatus according to the first embodiment of the present invention is applicable;

FIG. 2 is a circuit block diagram showing signal processes of a reader unit shown in FIG. 1;

FIGS. 3A, 3B and 3C are plan views showing the details of an operation unit shown in FIG. 2;

FIG. 4 is a diagram showing a memory map of an image memory shown in FIG. 2;

FIGS. 5A, 5B, 5C, 5D, 5E and 5F are diagrams for explaining an image storing method and an image reading method with respect to the image memory shown in FIG. 4;

FIGS. 6A, 6B, 6C, 6D and 6E are plan views for explaining a method of setting an image repeat function in the image forming apparatus according to the present invention;

FIGS. 7A, 7B, 7C, 7D and 7E are diagrams for explaining a method of generating an image-repeat image in the image forming apparatus according to the present invention;

FIG. 8 is a flow chart showing an example of a first control processing procedure in the image forming apparatus according to the present invention;

FIG. 9 is a circuit block diagram showing signal processes of a reader unit in the image forming apparatus according to the third embodiment of the present invention; and

FIG. 10 is a diagram for explaining a memory map of a storage medium which stores various data processing programs capable of being read by the image forming apparatus according to the present invention.

### DETAILED DESCRIPTION OF THE PREFERRED EMBODIMENTS

Hereinafter, the preferred embodiments of the present invention will be explained with reference to the attached drawings.

### First Embodiment

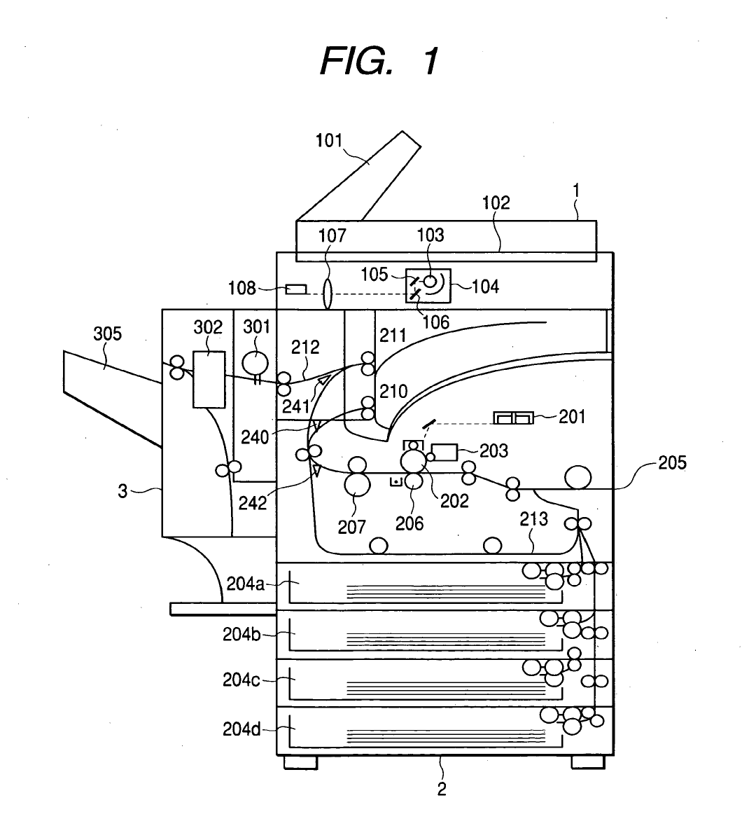

FIG. 1 is a cross section diagram showing an example of a copying machine to which an image forming apparatus according to the present invention is applicable. Hereinafter, the structure and the operation of the copying machine will be explained.

In FIG. 1, numeral 1 denotes a reader unit, and numeral 2 denotes a printer unit.

### (Explanation of Reader Unit 1)

Hereinafter, only the structure of the reader unit 1 will be explained. That is, the structure of the printer unit 2 will be explained later.

In the reader unit 1, numeral 101 denotes an original feeder on which original are put. When the originals put on the original feeder 101 are sequentially transported onto an original glass plate 102 one by one, the transported original is further moved to a predetermined position on the original glass plate 102. Then, a lamp 103 of a scanner unit 104 is turned on, and also the scanner unit 104 itself is moved, whereby the original is irradiated entirely. After then, the reflection light from the original is input to a CCD image sensor (simply called CCD hereinafter) 108 through mirrors 105 and 106 and a lens 107.

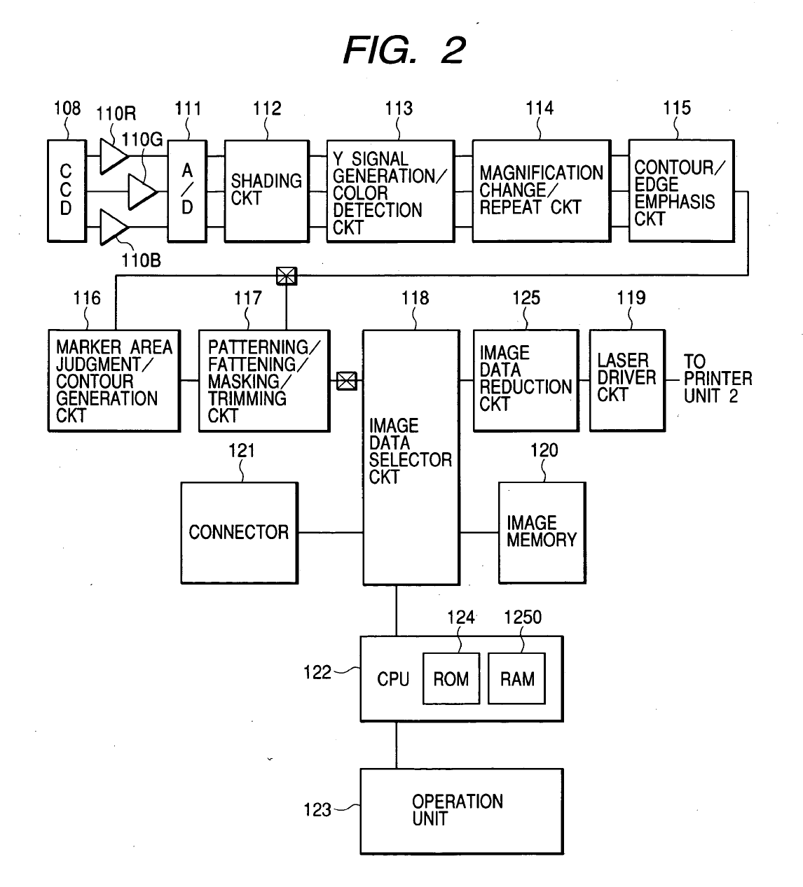

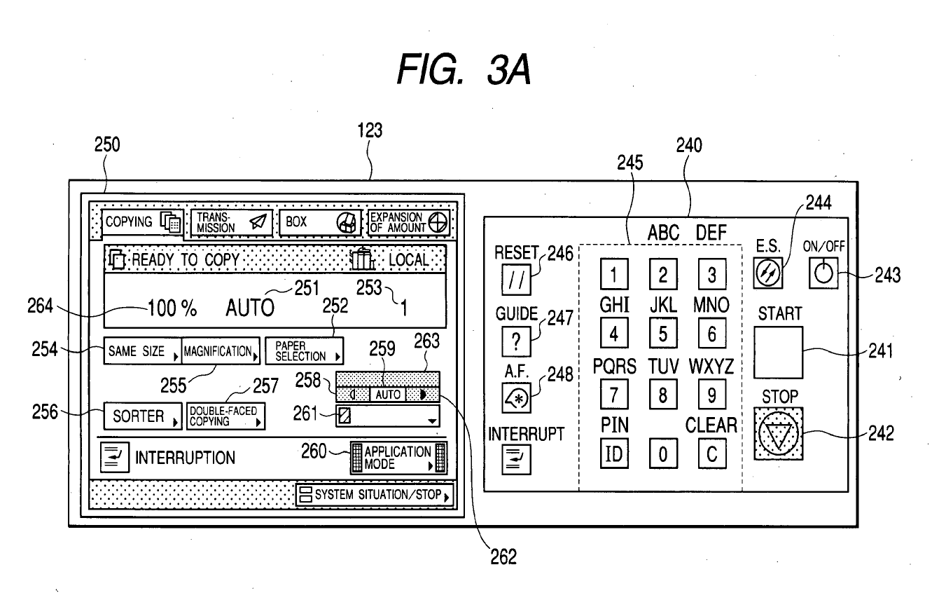

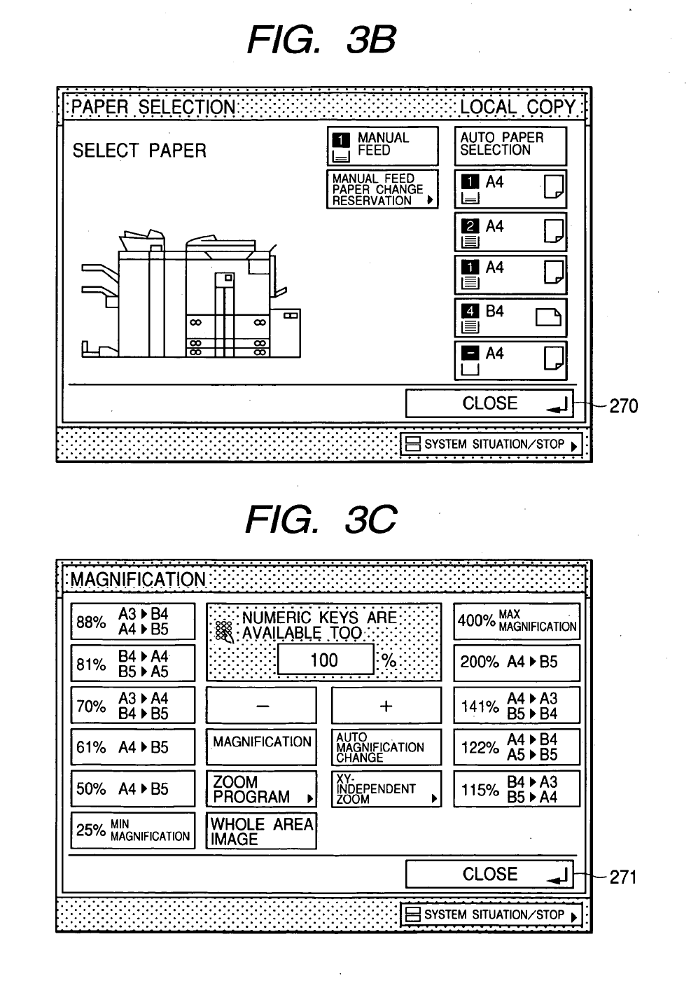

FIG. 2 is a circuit block diagram showing signal processes of the reader unit 1, and FIGS. 3A, 3B and 3C are plan views showing the details of an operation unit 123 of the reader unit 1. Here, in FIGS. 2, 3A, 3B and 3C, it should be noted that the same parts as those shown in FIG. 1 are respectively denoted by the same numerals as those shown in FIG. 1.

As shown in FIG. 2, the reflection light from the irradiated original is photoelectrically converted into R (red), G (green) and B (blue) color electrical signals (i.e., color information) by the CCD 108.

The color electrical signals output from the CCD 108 are then input respectively to amplifiers 110R, 110G and 110B and thus amplified in conformity with an input signal level of an A/D (analog-to-digital) converter 111 (in FIG. 2, simply described as A/D 111). Then, the output signal from the A/D converter 111 is input to a shading circuit 112, whereby unevenness of the light distribution of the lamp 103 and unevenness of the sensitivity of the CCD 108 are corrected. Further, the output signal from the shading circuit 112 is input to a Y (yellow) signal generation/color detection circuit 113 and a not-shown external interface switch circuit.

Here, the Y signal generation/color detection circuit 113 consists of a Y signal generation circuit and a color detection circuit. That is, the Y signal generation circuit performs calculation to the output signal of the shading circuit 112 by using a formula Y=0.3R+0.6G+0.1B to obtain a Y signal, and the color detection circuit separates the R, G and B signal into seven colors and then outputs the signal corresponding to each color.

Then, the output signal from the Y signal generation/color detection circuit 113 is input to a magnification change/repeat circuit 114.

The magnification change/repeat circuit 114 performs a magnification change in a main scan direction (i.e., vertical scan direction). Here, it is assumed that a magnification change in a sub scan direction (i.e., scan direction) is performed based on a scan speed of the scanner unit 104. Moreover, the magnification change/repeat circuit 114 can output plural same images. In any case, the output signal from the magnification change/repeat circuit 114 is input to a contour/edge emphasis circuit 115.

The contour/edge emphasis circuit 115 can perform edge emphasis and obtain contour information by emphasizing the high frequency component of the signal output from the magnification change/repeat circuit 114. Then, the output signal from the contour/edge emphasis circuit 115 is input to a marker area judgment/contour generation circuit 116 and a patterning/fattening/masking/trimming circuit 117.

The marker area judgment/contour generation circuit 116 reads the portion which has been written on the original by a marker pen of a designated color to generate marker contour information, and then outputs the generated marker contour information to the patterning/fattening/masking/trimming circuit 117.

The patterning/fattening/masking/trimming circuit 117 performs fattening, masking and trimming based on the input marker contour information. Moreover, the patterning/fattening/masking/trimming circuit 117 performs patterning based on the color detection signal generated by the Y signal generation/color detection circuit 113.

After then, when the signal output from the patterning/fattening/masking/trimming circuit 117 is finally output the printer unit 2, the output signal is selected by a later-described image data selector circuit 118. The selected signal is input to a laser driver circuit 119 through an image data reduction circuit 125. The laser driver circuit 119 converts the variously processed signal into the signal to be used to drive a laser, and then outputs the converted signal to the printer unit 2, whereby a visible image is formed in response to the signal output from the laser driver circuit 119.

Here, the patterning/fattening/masking/trimming circuit 117, a connector 121 capable of inputting/outputting various data from/to an external apparatus through a communication medium such as a network or the like, the image data reduction circuit 125, an image memory 120, and a CPU 122 are connected to the image data selector circuit 118.

The image data output from the image data selector circuit 118 is stored/read to/from a designated position on the image memory 120 in a later-described manner, in response to the instruction by the CPU 122, whereby an image rotation process and an image synthesis process on the image memory 120 can be performed.

The CPU 122 which is used to generally control the reader unit 1 as a whole consists of a ROM 124 of storing a control program, an error processing program and the like, a RAM 1250 capable of being used as a working area for the various programs, various timer control units, and the like.

Numeral 123 denotes the operation unit which consists of various kinds of keys, display units and the like. Here, the various kinds of keys are used to indicate the image editing contents of the image processes by the reader unit 1, and instruct image operations such as copy number setting and the like, and the display units are used to display the contents of the various operations.

Incidentally, the image forming apparatus (also called an image forming system) of the present embodiment can handle or manage not only job data (image data) output from the scanner unit 104 (i.e., the reader unit 1) but also job data output from an external apparatus such as a host computer or the like. Moreover, the image forming apparatus causes the printer unit 2 to print the job data through memory units (e.g., the image memory 120, a not-shown hard disk, and the like), and besides can transmit the processed data to the external apparatus. Furthermore, the image forming apparatus performs control so that later-described various processes can be applied to the above various kinds of data.

In addition, the image forming apparatus according to the present embodiment may be a so-called multifunctional-type apparatus which has a plural functions (or modes) such as a copying function (or a copying mode), a printer function (or a printer mode) and the like, and enables the printer unit 2 to output, through the memory units, the image data input from the reader unit 1 and the image data received from the external apparatus such as the host computer or the like, or may be a so-called single-functional-type apparatus which has only one function (e.g., only the copying function or only the printer function).

### (Explanation of Operation Unit 123)

FIGS. 3A, 3B and 3C are the plan views showing the details of the operation unit 123 of the reader unit 1. Here, it should be noted that display control itself to be performed to the operation unit 123 by a later-described control unit is one of the most important features of the present invention.

As shown in FIG. 3A, various keys and a liquid crystal display unit 250 of dot matrices are arranged on the operation unit 123.

The liquid crystal display unit 250 has a touch-panel structure, whereby key input can be performed by touching (i.e., depressing) an appropriate key display portion on the touch-panel structure. Thus, the liquid crystal display unit 250 is structured to function not only as an operation instruction unit for achieving the key input by a user but also as a notification unit for notifying the user of various information (e.g., guidance information, device status information, and the like).

A hard key group 240 consists of various kinds of hard keys. That is, numeral 243 denotes a power supply key, numeral 244 denotes an energy saving key, numeral 241 denotes a start key to be used to start a copying operation, numeral 242 denotes a stop key to be used to stop a copying operation, and numeral 246 denotes a return key to be used to return a set mode to a default state. Besides, a key group 245 consists of numeric keys “0” to “9” for inputting the number of copies, a zoom magnification and the like, and a clear key for clearing the data input by the numeric keys. Incidentally, the number of copies input by using the key group 245 is displayed on a liquid crystal display unit 253.

Numeral 247 denotes a guide key for causing the liquid crystal display unit 250 to display a guide screen of each function, and numeral 248 denotes a user mode key for performing various setting of the apparatus.

The liquid crystal display unit 250 displays the state of the apparatus, the number of copies, the magnification, a selected paper and various operation screens, and also displays several touch keys. Numeral 252 denotes a key for selecting a paper feed stage and auto paper feed. When the key 252 is depressed, a paper feed stage selection screen shown in FIG. 3B is displayed.

On the paper feed stage selection screen shown in FIG. 3B, when an appropriate paper feed stage is selected and then a close key 270 is depressed, this screen is closed and the selected paper feed stage is displayed on a display area 251.

Numerals 258 and 262 respectively denote keys for performing density adjustment, and the density actually adjusted by the keys 258 and 262 is displayed on a display area 263. Numeral 259 denotes a key for turning on/off an automatic density adjustment function, and the key 259 also functions to display the state of this function. Numeral 261 denotes a key for setting a photographic mode, a text mode and the like.

Numeral 254 denotes a key for setting same-size copy, and numeral 255 denotes a key for setting enlarged-size/reduced-size copying. That is, when the key 255 is depressed, an enlargement/reduction setting screen shown in FIG. 3C is displayed, whereby the enlarged-size/reduced-size copying can be set in detail. Then, when the enlarged-size/reduced-size copying is set and a close key 271 is depressed on the enlargement/reduction setting screen shown in FIG. 3C, this screen is closed, and the set magnification is displayed on a magnification display area 264 included in the display area 251.

Numeral 256 denotes a sorter key for setting a sort mode, and numeral 257 denotes a double-faced copying key for setting a double-faced copying mode.

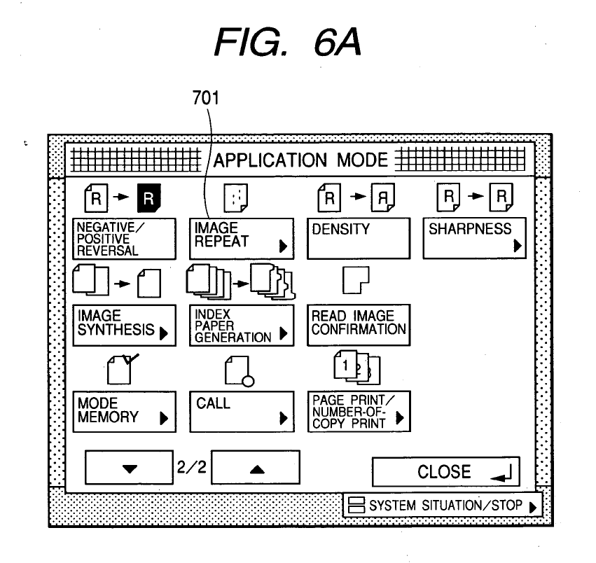

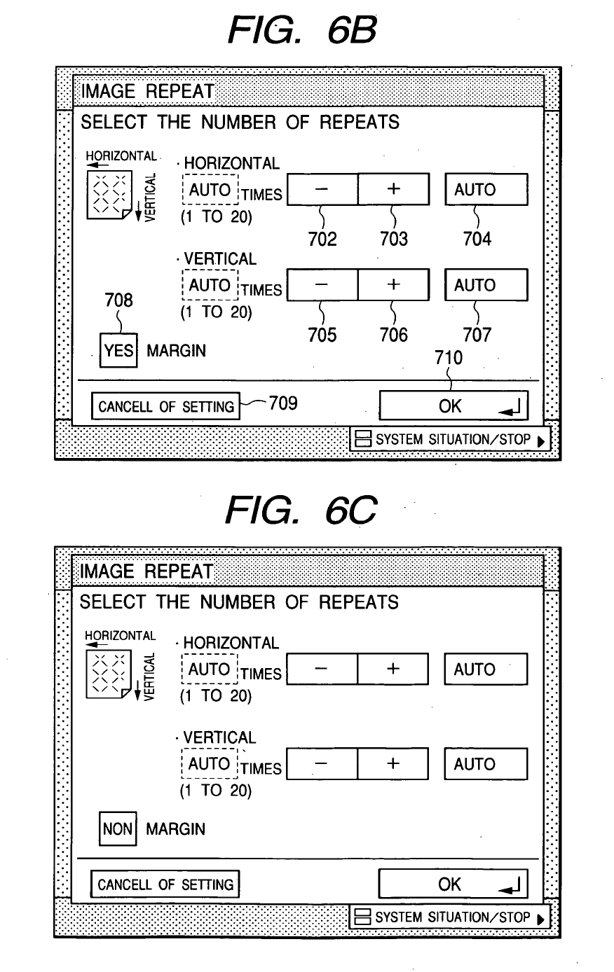

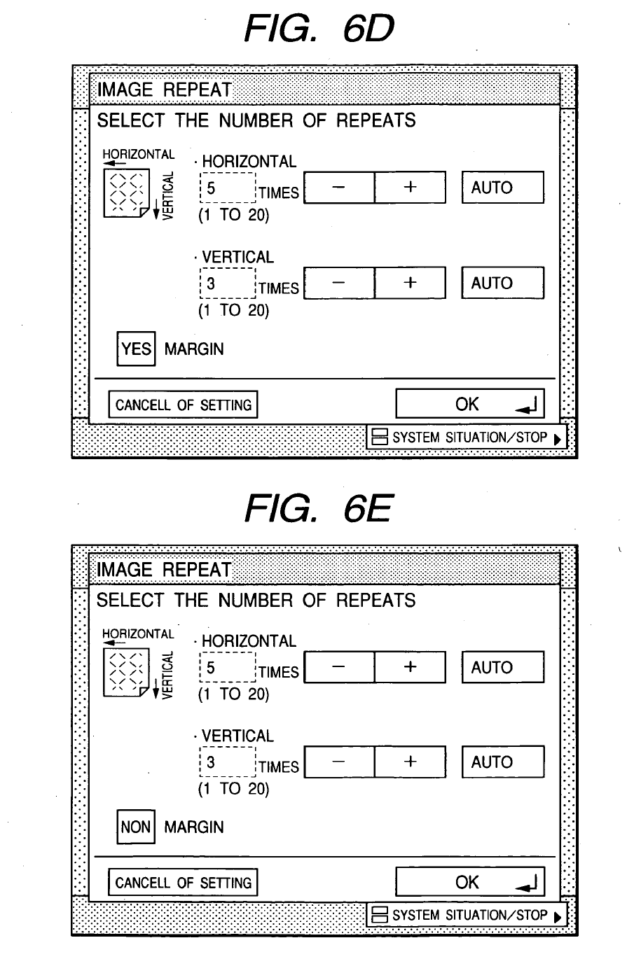

Numeral 260 denotes an application mode key. That is, when the application mode key 260 is depressed, an application mode screen shown in later-described FIG. 6A is displayed.

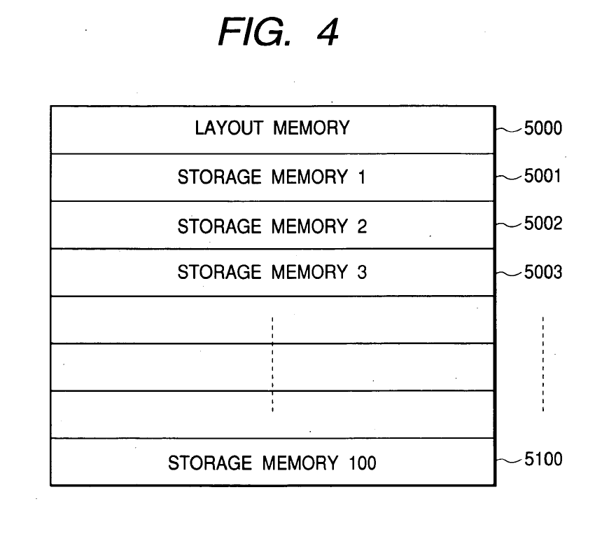

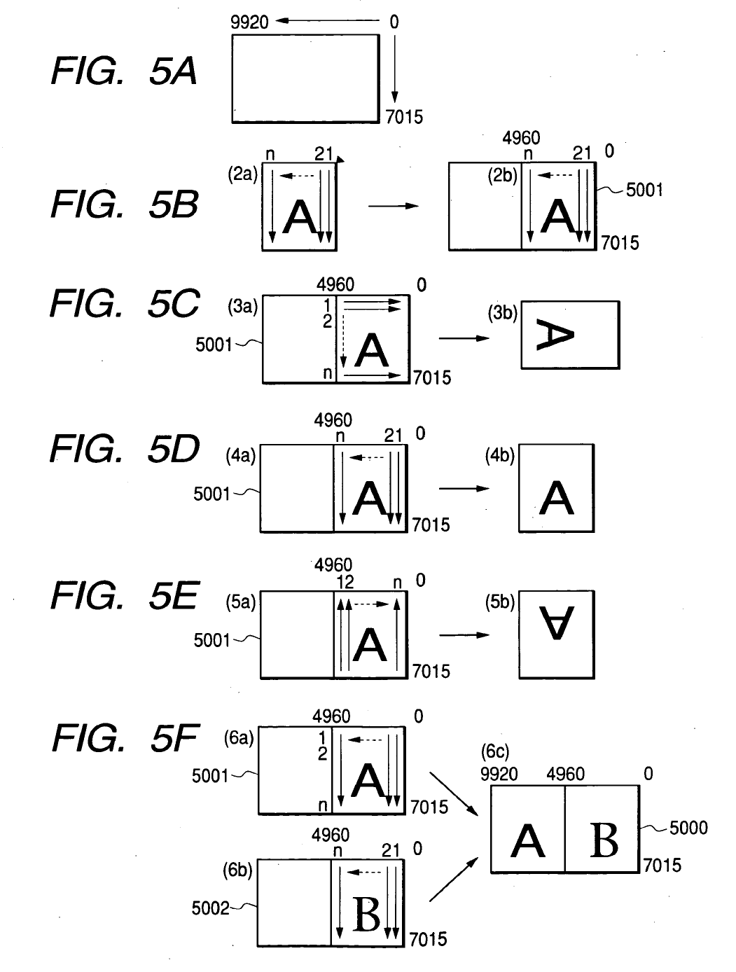

Hereinafter, a method of storing the image data in the image memory 120 and a method of reading the image data stored in the image memory 120 will be explained with reference to FIGS. 4, 5A, 5B, 5C, 5D, 5E and 5F.

FIG. 4 is the diagram showing a memory map of the image memory 120 shown in FIG. 2.

As shown in FIG. 4, the image memory (e.g., a hard disk or the like) 120 consists of a layout memory 5000 and plural storage memories 1 (5001) to 100 (5100). That is, in the present embodiment, the image memory 120 includes 100 storage memories, whereby totally 100 images can be stored.

FIGS. 5A, 5B, 5C, 5D, 5E and 5F are the diagrams for explaining the method of storing the image data in the image memory 120 and the method of reading the image data stored in the image memory 120.

Here, in the present embodiment, it is assumed that each of the layout memory 5000 and the storage memories 1 (5001) to 100 (5100) can store A3 image data at 600 dpi and has the size of vertical 7015 bits×horizontal 9920 bits. However, each of the layout memory 5000 and the storage memories 1 (5001) to 100 (5100) may have a structure other than that shown in FIG. 5A.

Subsequently, a case where an A4 original image is stored in the image memory will be explained by way of example with reference to FIG. 5B. Here, it should be noted that the CPU 122 performs various kinds of memory control to the image memory.

As in a state (2a) of FIG. 5B, an A4 original put on the original glass plate 102 (FIG. 1) is sequentially read in the direction indicated by the arrow.

At this time, as in a state (2b) of FIG. 5B, the address (0, 0) of the storage memory (e.g., the storage memory 1 (5001)) storing the read image data is set as the start position, and counting-up in the X direction and counting-up in the Y direction are respectively designated beforehand.

Then, when the first line is read, the read image data of the first line are sequentially written in the direction from the address (0, 0) to the address (0, 7015). Next, when the second line is read, a counter in the X direction performs counting-up by one, and the read image data of the second line are sequentially written in the direction from the address (1, 0) to the address (1, 7015). Subsequently, when the third line is read, the counter in the X direction performs counting-up by one, and the read image data of the third line are sequentially written in the direction from the address (2, 0) to the address (2, 7015). Like this, the writing operation is repeated until the read image data is written at the address (4960, 7015).

Next, a process where the image data written in the storage memory as shown in FIG. 5B is rotated clockwise by 90° and then read will be explained with reference to FIG. 5C.

When the image data stored in the storage memory (e.g., the storage memory 1 (5001)) is rotated clockwise by 90° and read, as in a state (3a) of FIG. 5C, the address (4960, 0) of the storage memory is set as the start position, and counting-down in the X direction and counting-up in the Y direction are respectively designated beforehand. Then, the image data of the first line are sequentially read in the counting-down manner in the direction from the address (4960, 0) to the address (0, 0). Next, a counter in the Y direction performs counting-up by one, and the image data of the second line are sequentially read in the direction from the address (4960, 0) to the address (0, 1). By sequentially reading the image data like this, as in a state (3b) of FIG. 5C, the image data rotated clockwise by 90° can be read from the storage memory.

Next, a process where the image data written in the storage memory as shown in FIG. 5B is read without rotating it will be explained with reference to FIG. 5D.

When the image data stored in the storage memory (e.g., the storage memory 1 (5001)) is read without rotating it, as in a state (4a) of FIG. 5D, the address (0, 0) of the storage memory is set as the start position, and counting-up in the X direction and counting-up in the Y direction are respectively designated beforehand. Then, the image data of the first line are sequentially read in the counting-up manner in the direction from the address (0, 0) to the address (0, 7015). Next, the counter in the X direction performs counting-up by one, and the image data of the second line are sequentially read in the direction from the address (1, 0) to the address (1, 7015). By sequentially reading the image data like this, as in a state (4b) of FIG. 5D, the image data can be read from the storage memory.

Therefore, by reading the A4 original (the state (2a) of FIG. 5B) in the direction as in the state (4a) of FIG. 5D, the image data can be read without rotating it.

Next, a process where the image data written in the storage memory as shown in FIG. 5B is rotated clockwise by 180° and then read will be explained with reference to FIG. 5E.

When the image data stored in the storage memory (e.g., the storage memory 1 (5001)) is rotated clockwise by 180° and read, as in a state (5a) of FIG. 5E, the address (0, 7015) of the storage memory is set as the start position, and counting-down in the X direction and counting-down in the Y direction are respectively designated beforehand. Then, the image data of the first line are sequentially read in the counting-down manner in the direction from the address (4960, 7015) to the address (4960, 0). Next, the counter in the X direction performs counting-down by one, and the image data of the second line are sequentially read in the direction from the address (4959, 7015) to the address (4959, 0). By sequentially reading the image data like this, as in a state (5b) of FIG. 5E, the image data rotated clockwise by 180° can be read from the storage memory.

Therefore, by reading the A4 original (the state (2a) of FIG. 5B) in the direction as in the state (5a) of FIG. 5E, the image data rotated clockwise by 180° can be read.

Next, a process where the image data written in the plural storage memories are respectively read and synthesized together on the layout memory 5000 will be explained with reference to FIG. 5F.

As in states (6a) and (6b) of FIG. 5F, the image data stored respectively in the storage memories (e.g., the storage memory 1 (5001) and the storage memory 2 (5002)) are read independently. Then, as in a state (6c) of FIG. 5F, the image data are written at a desired position on the layout memory 5000, whereby the image data written in the plural storage memories can be synthesized on the image memory 120.

### (Explanation of Printer Unit 1)

Hereinafter, the structure and the operation of the printer unit 2 will be explained with reference to FIG. 1.

In FIG. 1, numeral 201 denotes an exposure control unit which converts the image signal input to the printer unit 2 into a modulated light signal (i.e., light) so as to irradiate a photosensitive body 202. Then, a latent image formed on the photosensitive body 202 by the irradiated light is developed by a developing unit 203. Besides, a transfer paper is fed and transported from any one of transfer paper stacking units 204a and 204d and a manual paper feed unit 205 in exact timing with the leading edge of the developed image, and the developed image is transferred to the transported transfer paper by a transfer unit 206. Subsequently, the transferred image is fixed to the transfer paper by a fixing unit 207, and the obtained transfer paper is then discharged to any one of paper discharge units 210, 211 and 212.

For example, when a paper discharge unit control member 240 is inclined toward the direction opposite to the paper discharge unit 210, the transfer paper can be discharged to the paper discharge unit 210. Moreover, when the paper discharge unit control member 240 is inclined toward the paper discharge unit 210 and a paper discharge unit control member 241 is inclined toward the direction opposite to the paper discharge unit 211, the transfer paper can be discharged to the paper discharge unit 211. In these cases, the recording paper is discharged with the printed face thereof downward, whereby back-face paper discharge is achieved.

Furthermore, when the recording paper is discharged to the paper discharge unit 212, the paper discharge unit control member 240 is inclined toward the paper discharge unit 210 and the paper discharge unit control member 241 is inclined toward the direction opposite to the paper discharge unit 211, whereby the recording paper is once transported to the paper discharge unit 211. Here, when the recording paper is transported to the paper discharge unit 211, the back-face paper discharge is performed. Therefore, by controlling the paper discharge unit control member 241 to be horizontal and reversing the transportation direction of the recording paper, the recording paper is discharged toward the direction of the paper discharge unit 212. Here, it should be noted that the back-face paper discharge of the recording paper can be performed to the paper discharge unit 212 when the recording paper is directly discharged to the paper discharge unit 212 without transporting it to the paper discharge unit 211.

Then, the recording (transfer) paper is further transported from the paper discharge unit 212 to a finisher 3. In the finisher 3, punching is performed to the paper on which the image has been formed when a punching function is activated, and the processed paper is further transported to a stapler 302. In the stapler 302, stapling is performed to the recording papers when a stapling function is activated, and the processed papers are then discharged to a paper discharge tray 305 of the finisher 3. As just described, in the present embodiment, the punching process and the stapling process can be performed, whereby a punching mode and a stapling mode can selectively be set by the user through the operation unit.

Subsequently, a method of outputting the sequentially read images to the front and back faces of one output paper (i.e., double-faced copying operation) will be explained.

When the double-faced copying operation is performed by the copying machine shown in FIG. 1 (i.e., in case of a double-faced printing mode), the printing begins from the back face of the recording paper. Therefore, it waits until the fact that there are two or more originals is determined. Then, the double-faced printing starts at a time when the fact that the two or more originals exist is determined, and the original of the second page is first printed on the back face of the recording paper. Subsequently, the image-printed recording paper is fixed by the fixing unit 207, and the fixing-processed recording paper is once transported to the paper discharge unit 210. Next, the transportation direction of the recording paper is reversed and changed, whereby the recording paper is transported to a paper re-feed transfer paper stacking unit 213 through a member 242. After then, when the next original of the first page is prepared, the original image is read in the same manner as above. In this case, the recording paper to which the read image is printed is fed from the paper re-feed transfer paper stacking unit 213, and the original image of the first page is actually printed on the front face of the recording paper.

Eventually, the two original images are output and printed to both the faces of the same recording paper in the order of first-page original and second-page original, and the image-printed recording paper is discharged to any one of the paper discharge units 210, 211 and 212. At that time, because the back-face paper discharge is performed, the face of the recording paper on which the first-page original has been printed is discharged downward, whereby the double-faced printing in due printing order can be performed.

Next, a method of setting the image repeat function in the image forming apparatus according to the present invention will be explained with reference to FIGS. 6A, 6B, 6C, 6D and 6E.

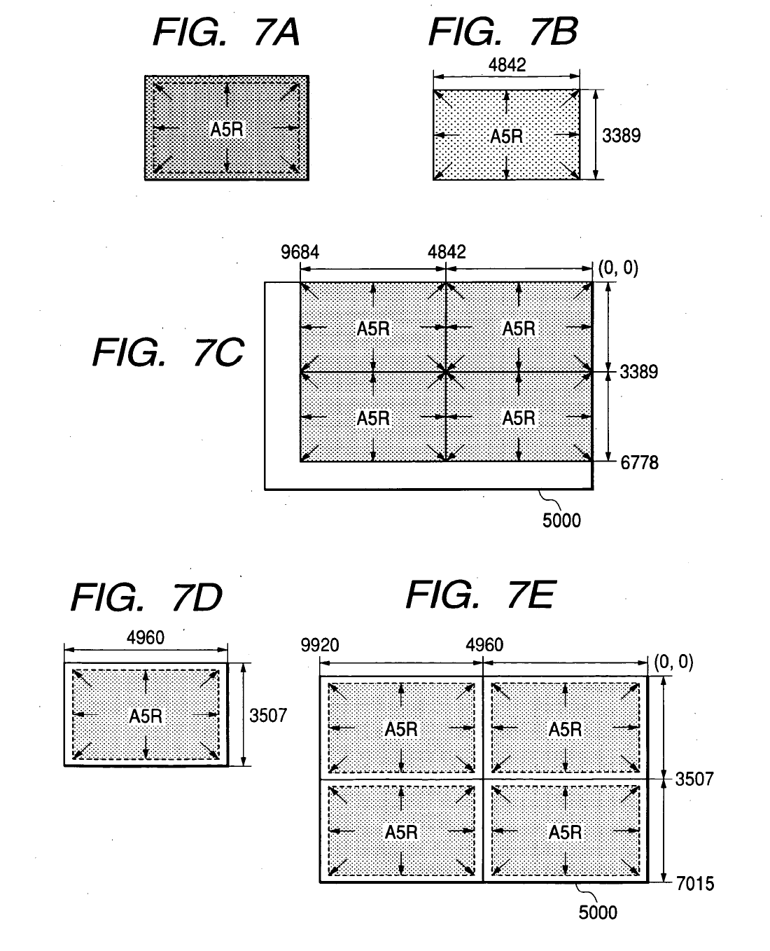

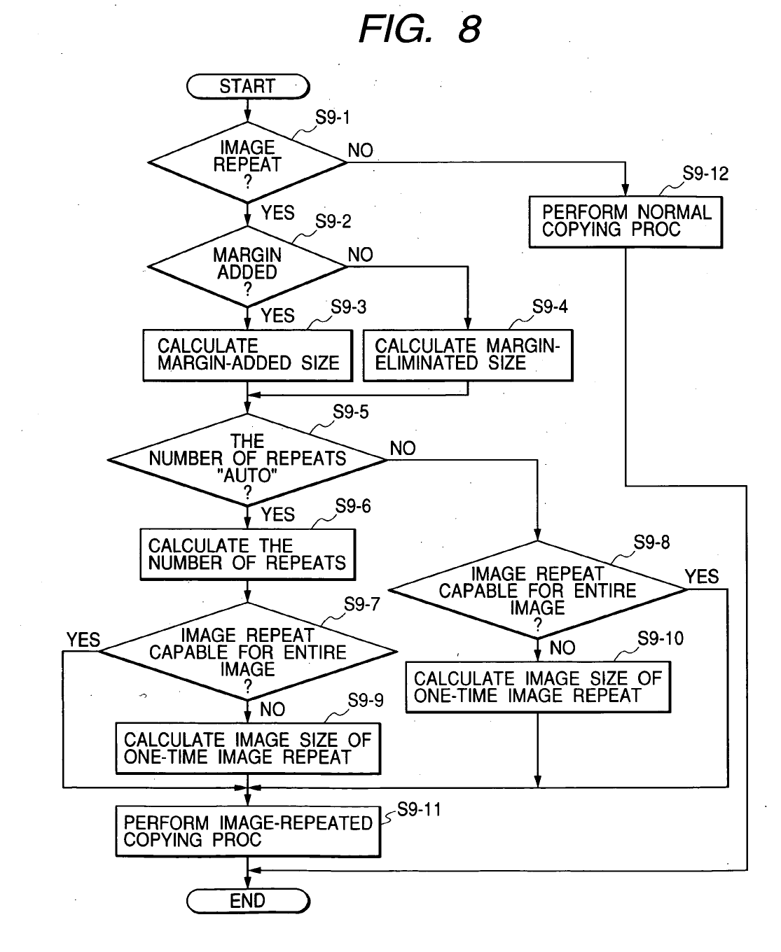

That is, FIGS. 6A to 6E are the plan views for explaining the method of setting the image repeat function in the image forming apparatus according to the present invention. Here, it should be noted that an image repeat mode in the present embodiment is an operation mode in which the plural same images can be arranged and formed on the same face of one recording paper, and is also an image forming mode in which the plural same image data (in the present embodiment, also called plural same images, plural same document data, or simply same data) can be arranged and generated in both the horizontal direction (i.e., the paper transportation direction) and the vertical direction (i.e., the direction perpendicular to the paper transportation direction) on the same face of the one recording paper (see FIGS. 7A to 7E). Of course, it is possible to arrange plural same screens only in any one of the horizontal direction and the vertical direction on the same face of the one recording paper, and it is also possible to cause a user to select through the operation unit how many the same images should be arranged in which direction on the same face of the one recording paper. Moreover, when automatic selection is requested by the user through the operation unit, it is automatically determine by the control unit (e.g., the CPU 122) of the present embodiment how many the same images should be arranged in which direction on the basis of judgment material data such as original size data, recording paper size data and the like.

In the present embodiment, it should be noted that the vertical direction is also called the main scan direction (i.e., the direction parallel with the image reading direction of the reading element of the reader unit 1), a longitudinal direction, or simply a first direction. Besides, it should be noted that the horizontal direction is also called the sub scan direction (i.e., the direction parallel with the original transportation direction or the recording paper transportation direction), a lateral direction, or simply a second direction perpendicular to the first direction. Incidentally, even if the definitions of the first direction and the second direction are inverted respectively, the present embodiment is applicable.

FIG. 6A shows an application mode screen which is displayed on the liquid crystal display unit 250 under the control of the control unit (e.g., the CPU 122) of the present embodiment in response to that the application mode key 260 on the operation screen of FIG. 3A is depressed by the user. As shown in FIG. 6A, plural image processing mode keys including an image repeat key 701 capable of being depressed by the user are displayed on the application mode screen. When the image repeat key 701 is depressed on the application mode screen, it is controlled by the control unit to select the image repeat mode, and it is also controlled by the control unit to enable the display unit 250 to display image repeat screens (i.e., image repeat details screens) shown in FIGS. 6B to 6E so that detailed setting parameters in the image repeat mode can be set by the user.

In FIG. 6B, numeral 702 denotes a key to be used to reduce the number of times of image repeat in the sub scan direction (i.e., the lateral direction), and numeral 703 denotes a key to be used to increase the number of times of image repeat in the sub scan direction (i.e., the lateral direction). Here, it should be noted that the term “the number of times of image repeat”, the term “the number of times of repeat” and the term “the number of repeats” are substantially equivalent throughout the specification. That is, by using the keys 702 and 703, the user can manually select the number of same images to be arranged and formed in the horizontal direction (i.e., the lateral direction) on the same face of the one paper in the image repeat mode (that is, the number of times of image repeat in the second direction on the same face of the one paper). Numeral 704 denotes a key to be used to input an instruction to cause the control unit (e.g., the CPU 122) to automatically set the number of times of image repeat in the sub scan direction (i.e., the lateral direction, or the second direction on the same face of the one paper) on the basis of the original size data, the output paper size data and the like.

Besides, numeral 705 denotes a key to be used to reduce the number of times of image repeat in the main scan direction (i.e., the longitudinal direction), and numeral 706 denotes a key to be used to increase the number of times of image repeat in the main scan direction (i.e., the longitudinal direction). That is, by using the keys 705 and 706, the user can manually select the number of same images to be arranged and formed in the vertical direction (i.e., the longitudinal direction) on the same face of the one paper in the image repeat mode (that is, the number of times of image repeat in the first direction on the same face of the one paper). Numeral 707 denotes a key to be used to input an instruction to cause the control unit (e.g., the CPU 122) to automatically set the number of times of image repeat in the main scan direction (i.e., the longitudinal direction, or the first direction on the same face of the one paper) on the basis of the original size data, the output paper size data and the like.

Besides, it is controlled by the control unit (e.g., the CPU 122) controlling the operation unit 123 including the display unit 250 to set the display range (i.e., an image repeat number selectable range in the second direction on the same face of the one recording paper) of the number of same images to be arranged in the lateral direction on the same face of the one recording paper (this range can be selected and designated by the user through the keys 702 and 703 on the operation screen of FIG. 6B) to be within a range of 20 candidates. Likewise, it is controlled by the control unit (e.g., the CPU 122) to set the display range (i.e., an image repeat number selectable range in the first direction on the same face of the one recording paper) of the number of same images to be arranged in the longitudinal direction on the same face of the one recording paper (this range can be selected and designated by the user through the keys 705 and 706 on the operation screen of FIG. 6B) to be within a range of 20 candidates. For example, when the images of which the number exceeds 20 are selected by the user (that is, the number of times of image repeat exceeds 20 times), it is display-controlled so that the set value returns to 20. Besides, when the 21 images are selected by the user (that is, the number of times of image repeat is set to 20), it is display-controlled to subtract “20” from the set number “21” so that the selected number becomes “1” and thus cause to perform the operation control according to the obtained selected number. Thus, when the set value (i.e., “21” or more in this case) exceeding the range permitted to be selected is designated, it is controlled to invalidate such designation. That is, for example, the set value is returned within the designated range and then execution of the image repeat function is permitted, or execution of the image repeat function itself is inhibited.

Moreover, it is controlled by the control unit (e.g., the CPU 122) to cause the display unit 250 to display a key 708 by which the user can select and instruct whether or not to add a margin in the image repeat mode.

The key 708 is used to cause the display unit 250 of the operation unit 125 to display the operation screen by which the user can select and instruct whether to cause the printer unit 2 of the image forming apparatus to execute a first mode or a second mode. Here, it should be noted that the first mode is the mode of performing layout to form the plural same images being the processing target in the image repeat mode so that the adjacent two of these images are arranged at a predetermined interval (e.g., 2 mm or 4 mm) respectively in the first direction (longitudinal direction) and the second direction (lateral direction) on the same face of the one paper. On one hand, it should be noted that the second mode is the mode of performing layout to form the plural same images so that the adjacent two of these images are not arranged at the predetermined interval in question respectively in the first direction (longitudinal direction) and the second direction (lateral direction) on the same face of the one paper. For example, in the second mode, the distance between the adjacent images is set to 0 mm, that is, it is inhibited to arrange the adjacent images at the predetermined interval in question.

More specifically, when it is set through the key 708 to add the margin (e.g., “YES” is checked by the key 708 on the operation screen of FIG. 6D), the control unit (e.g., the CPU 122) controls the image memory and the printer unit 2 to execute a layout process (also called a first layout process) in the image repeat mode. That is, in the first layout process, the adjacent two of the plural same images (e.g., five same images arranged in the lateral direction as shown in FIG. 6D) corresponding to the number of times of image repeat in the lateral direction on the same face of the one paper manually or automatically determined through the keys 702 to 704 on the image repeat details screen including the key 708 and to be arranged and formed in the second direction (lateral direction) on the same face of the one paper are arranged in the second direction (lateral direction) at an interval of at least a predetermined distance (e.g., 10 mm), and the adjacent two of the plural same images (e.g., three same images arranged in the longitudinal direction as shown in FIG. 6D) corresponding to the number of times of image repeat in the longitudinal direction on the same face of the one paper manually or automatically determined through the keys 705 to 707 on the image repeat details screen including the key 708 and to be arranged and formed in the first direction (longitudinal direction) on the same face of the one paper are arranged in the first direction (longitudinal direction) at an interval of at least a predetermined distance (e.g., 10 mm).

On the contrary, when it is set through the key 708 not to add the margin (e.g., “NON” is checked by the key 708 on the operation screen of FIG. 6D), the control unit (e.g., the CPU 122) controls the image memory and the printer unit 2 to execute a layout process (also called a second layout process) in the image repeat mode. That is, in the second layout process, the adjacent two of the plural same images (e.g., five same images arranged in the lateral direction as shown in FIG. 6D) corresponding to the number of times of image repeat in the lateral direction on the same face of the one paper manually or automatically determined through the keys 702 to 704 on the image repeat details screen including the key 708 and to be arranged and formed in the second direction (lateral direction) on the same face of the one paper are arranged in the second direction (lateral direction) without an interval of at least the predetermined distance (for example, it is inhibited to arrange the adjacent images at the interval of 10 mm, and the distance between the adjacent images is set to 0 mm, that is, the plural images are disposed to be closed up), and the adjacent two of the plural same images (e.g., three same images arranged in the longitudinal direction as shown in FIG. 6D) corresponding to the number of times of image repeat in the longitudinal direction on the same face of the one paper manually or automatically determined through the keys 705 to 707 on the image repeat details screen including the key 708 and to be arranged and formed in the first direction (longitudinal direction) on the same face of the one paper are arranged in the first direction (longitudinal direction) without an interval of at least the predetermined distance (for example, it is inhibited to arrange the adjacent images at the interval of 10 mm, and the distance between the adjacent images is set to 0 mm, that is, the plural images are disposed to be closed up).

As just described, the control unit (e.g., the CPU 122) performs the control to selectively perform one of the first layout process (also called a first operation sequence in the image repeat mode) and the second layout process (also called a second operation sequence in the image repeat mode) in the image repeat mode in response to the user's selected state based on the key 708.

In any of the first layout process and the second layout process, it may be controlled by the control unit (e.g., the CPU 122) to set the image storage position on the image memory so as to achieve the above layout, generate the output image corresponding to the one recording paper on the memory, and actually print out the generated image of the one recording paper on the one recording paper as it is. Moreover, it may be controlled not to perform any address control on the memory, but to control, when the image is actually printed on the recording paper, the print position so as to achieve the above layout.

In any case, though which process is performed with which unit, it may have a structure capable of outputting an output result as generated data in accordance with a user's instruction.

According to the present embodiment, it is possible to perform the above layout control (including memory control and print control) in the image repeat mode, and also provide the method of arranging the positions of the plural same images in both the first direction and the second direction on the same face of the one recording paper under the control of the control unit.

As just described, the candidates of image processes (i.e., image editing processes such as the above various layout processes) capable of being selected and designated by the user in the image repeat function are widely prepared, so that the image process being in conformity with the user's demand can be selected and performed in the image repeat mode. Thus, it is possible to cope with and solve the situation, the inconvenience and the like in the above related background art, whereby it is possible to appropriately meet user's various needs.

Incidentally, FIG. 7C shows an example of the output result printed on the recording paper when it is set through the key 708 not to add the margin in the image repeat mode. On one hand, FIG. 7E shows an example of the output result printed on the recording paper when it is set through the key 708 to add the margin in the image repeat mode.

In the present embodiment, when the first layout process (i.e., the first operation sequence) is selected by the user through the key 708 in the image repeat function, the control unit (e.g., the CPU 122) arranges and forms the plural same images, being the processing target in the image repeat function and to be arranged respectively in the longitudinal direction and the lateral direction on the same face of the one paper, with the margin corresponding to the predetermined interval (e.g., 10 mm). Here, to form the margin in question, the control unit (e.g., the CPU 122) causes the image processing unit to perform the following image process. More specifically, the control unit causes to perform a deletion process for deleting the images existing in the image formed area (i.e., the margin area) in the vicinity of the portion where the adjacent two of the plural same images are contacted with each other on the same face of the one paper (for example, deleting the image of 10 mm in each margin on the same face of the one paper). On one hand, instead of the above deletion process, the control unit shifts the image so as to secure the margin. Otherwise, in addition to the image shifting to secure the margin, the control unit performs an image reduction process so that the image can be held within an effective printing area. It should be noted that it is possible to adopt any of the above methods. In any case, the above image processes are performed on the memory, and the processed image is printed on the recording paper. By adopting these methods, as shown in FIG. 7E, it is possible to print and output the adjacent two of the plural same images with the margin corresponding to the predetermined interval on the same face of the one paper.

Incidentally, it is possible for the user through the operation unit to set an arbitrary value (e.g., within a range of 0 mm to 20 mm) as the value of the predetermined interval corresponding to the margin every time the first layout process is selected in the image repeat mode (that is, every time it is set through the key 708 to add the margin). Besides, instead of such user setting, it is possible to set and store in advance a default value (e.g., 10 mm) in the memory of the image forming apparatus. In this case, when the first layout process is selected, it is controlled by the control unit (e.g., the CPU 122) to perform the image process so as to secure the margin area according to the stored default value.

As just described, according to the present embodiment, in case of securing the margin area by the first layout process in the image repeat mode, it is possible to cope with various image processes. In any case, when the image-printed recording paper on which the plural same images have been printed by the image repeat function is cut out in units of image by the cutting machine or manually by the user, the margin corresponding to the predetermined interval by which each of the plural same images can be cut out without causing any problem of partial lost portion of the image and without deteriorating image quality may be secured and formed by the first layout process in the image repeat mode under the control of the control unit (i.e., the CPU 122).

Incidentally, in the present embodiment, the plural same images can be arranged and formed respectively in the longitudinal direction and the lateral direction by the image repeat function. However, in response to a user's instruction, it is possible to perform the layout process so as to arrange and form the plural same images only in either one of the longitudinal direction and the lateral direction. When it is set by the user through the operation unit to arrange the same images in both the longitudinal direction and the lateral direction in the image repeat function, it is at least controlled by the control unit (i.e., the CPU 122) to lay out the plural same images respectively in the longitudinal direction (i.e., the first direction) and the lateral direction (i.e., the second direction) on the same face of the one recording paper. Besides, when it is set by the user through the operation unit to arrange the same images in only either one of the longitudinal direction and the lateral direction in the image repeat function, it is controlled by the control unit to lay out the plural same images only in the direction designated by the user from among the longitudinal direction (i.e., the first direction) and the lateral direction (i.e., the second direction) on the same face of the one recording paper. Then, even in such a case, it is controlled by the control unit (i.e., the CPU 122) to enable the user to select through the key 708 whether or not to add the margin, and thus reflect the user's instruction set by the key 708 on the output result. As described above, by widely preparing the candidates of layout processes capable of being selected by the user in the image repeat function, it is possible to further increase the above effects.

Moreover, in the present embodiment, as described above, it is controlled to cause the predetermined unit (i.e., the image storage unit, the printer unit, or the like) to perform the actual layout process and further to cause the display unit 250 of the operation unit 123 to perform the display control as shown in FIGS. 6A to 6E in consideration of improvement of user's operability.

For example, when the application mode key 260 on the operation screen shown in FIG. 3A is depressed by the user, the control unit (i.e., the CPU 122) causes the display unit 250 to display the operation screen including the image repeat key 701 to select the image repeat mode (the screen shown in FIG. 6A). Then, when the image repeat mode is selected by the user through the key 701 on the operation screen shown in FIG. 6A, the control unit (i.e., the CPU 122) causes the display unit 250 to display the operation screen (the operation screen shown in FIG. 6B). Here, as shown in FIGS. 6B to 6E, the operation screen includes the keys 705 to 707 for setting the number of the same images arranged and formed in the longitudinal direction (i.e., the first direction) on the same face of the one recording paper in the image repeat mode, the keys 702 to 704 for setting the number of the same images arranged and formed in the lateral direction (i.e., the second direction) on the same face of the one recording paper in the image repeat mode, and the key 708 for causing the user to select whether to arrange each of the plural same images formed respectively in the longitudinal direction (i.e., the first direction) and the lateral direction (i.e., the second direction) on the same face of the one recording paper in the image repeat function at the predetermined interval (i.e., arranging the image with the margin) or arrange each of the plural same images without the predetermined interval (i.e., arranging the image without adding the margin but by closing up the adjacent images). More specifically, it should be noted that the key 708 is used to select whether to perform the first layout process or the second layout process in the image repeat mode.

That is, it is controlled by the control unit (i.e., the CPU 122) to cause the display unit 250 to display the keys 705 to 707, display the keys 702 to 704, and display the key 708. Incidentally, these keys are disposed on the same operation screen as shown in FIG. 6B, but may be disposed respectively on different operation screens. In any case, the image display and the operation environment easy to be used by the user may be provided.

Then, under the above display control, the control unit (i.e., the CPU 122) selectively performs the first layout process or the second layout process in the image repeat mode in accordance with the instruction selected by the user.

Thus, it is possible to further increase the above effects, further increase the usability for the user in the image repeat function, and explicitly notify the user that the first layout process (for adding the margin) and the second layout process (not for adding the margin) in the image repeat function, whereby the user can effectively use the image repeat function. Thus, it enables the user to easily select a desired one of the first layout process and the second layout process in the image repeat function, whereby a flexible image repeat environment capable of coping with user's various needs can be provided in consideration of the operability, the usability for the user, and the like.

Moreover, numeral 710 denotes a key to be used to determine the repeat setting. That is, when the key 710 is depressed after the operation was performed through the keys 702 to 708, the image repeat screen is closed, whereby the image repeat setting is determined. After then, when the start key 241 is depressed, the control unit causes the printer unit 2 to perform an image repeat copying operation.

Furthermore, numeral 709 denotes a key to be used to entirely clear the key operations. When the key 709 is depressed, the image repeat screen is closed, and the image repeat setting is released.

Next, a method of forming an image-repeat image under the control of the control unit (i.e., the CPU 122) in the image forming apparatus of the present invention will be explained with reference to FIGS. 7A to 7E.

FIGS. 7A to 7E are the diagrams for explaining the method of generating the image-repeat image in the image forming apparatus according to the present invention. Here, in the present embodiment, it is assumed that the margin is set to 2.5 mm. However, as described above, a margin other than 2.5 mm may be set. Moreover, the margin may be set beforehand as a fixed value or designated manually by the user.

### (Explanation of Setting of No Margin in Image Repeat Mode)

Then, a case where it is set through the key 708 on the operation screen of FIGS. 6B to 6E not to add the margin will be explained hereinafter.

Here, it will be explained the processes to be performed under the control of the control unit (i.e., the CPU 122) in the case where the image repeat mode is selected by the user through the key 701 on the operation screen of FIG. 6A, it is selected by the user through the key 708 on the operation screen of FIG. 6B not to add the margin, the size of the original corresponding to the output image is “A5R” (this parameter is based on the original size input data obtained through the operation unit or the original size information obtained from the original size sensor of the reader unit 1), the size of the recording paper on which the image is formed is “A3” (this parameter is based on the output paper size input data obtained through the operation unit or the output paper size information obtained from the recording paper size sensor provided in the paper feed cassette of the printer unit 2), a process “sub scan direction (lateral direction)=twice” is set through the key 702, 703 or 704 on the operation screen of FIG. 6B, and a process “main scan direction (longitudinal direction)=twice” is set through the key 705, 706 or 707 on the operation screen of FIG. 6B.

Incidentally, in the process “sub scan direction (lateral direction)=twice”, the output process is performed so that the input two same images are arranged and formed in the horizontal direction (i.e., the second direction) on the same face of the one recording paper in the image repeat mode. On one hand, in the process “main scan direction (lateral direction)=twice”, the output process is performed so that the input two same images are arranged and formed in the vertical direction (i.e., the first direction) on the same face of the one recording paper in the image repeat mode. Here, please note that the process “sub scan direction (lateral direction)=twice” and the process “main scan direction (longitudinal direction)=twice” can be set simultaneously with respect to one print job. That is, in this case, the four same images (i.e., two images in the longitudinal direction and two images in the lateral direction) are arranged and formed on the same face of the one recording paper.

In the present embodiment, because the A5R size is 210 mm×148.5 mm and the margin is 2.5 mm, the size (i.e., the size actually subjected to the image repeat function) is obtained by subtracting the dotted margin (FIG. 7B) from the A5R original image (FIG. 7A), and this size is 205 mm×143.5 mm. Thus, if it is assumed that the image is formed based on 600 dpi, the above size is represented as 4842 dots×3389 dots.

In this case, after the original was read, it is controlled by the control unit (i.e., the CPU 122) to store the image data (FIG. 7B) of 4842 dots×3389 dots obtained by trimming the margin with assistance of the patterning/fattening/masking/trimming circuit 117 in any one of the plural storage memories 1 (5001) to 100 (5100).

Then, it is controlled by the control unit to write the image data (FIG. 7B) on the storage memory by 4842 dots×3389 dots from the address (0, 0) on the layout memory 5000, write the image data by 4842 dots×3389 dots from the address (0, 3389), write the image data by 4842 dots×3389 dots from the address (4842, 0), and write the image data by 4842 dots×3389 dots from the address (4842, 3389). Thus, the image data shown in FIG. 7C is formed on the layout memory 5000, the formed image data is read and transferred to the printer unit 2, and the transferred image data is printed, whereby the image as shown in FIG. 7C is formed on the A3 recording paper.

As just described, when it is selected by the user not to add the margin in the image repeat function, that is, when the second layout process is instructed, the control unit (i.e., the CPU 122) causes the printer unit 2 to perform the printing so that the plural same images (the images themselves correspond to the input images of one page) which are arranged in the horizontal direction on the same face of the one recording paper and of which the number corresponds to the number set based on the user's operation and the plural same images (corresponding to the same images as above) which are arranged in the vertical direction on the same face of the one recording paper and of which the number corresponds to the number set based on the user's operation are arranged and formed in the respective directions without the margin (that is, by closing up the images).

Incidentally, the printing is an example of the output process in the present embodiment. That is, it is possible to perform, as the output process, a transmission process for transmitting the layout-processed image data to an external apparatus, and a display process for causing the display unit to preview-display the layout-processed image.

### (Explanation of Setting of Margin in Image Repeat Mode)

Then, a case where it is set through the key 708 on the operation screen of FIGS. 6B to 6E to add the margin will be explained hereinafter.

Here, it will be explained the processes to be performed under the control of the control unit (i.e., the CPU 122) in the case where the image repeat mode is selected by the user through the key 701 on the operation screen of FIG. 6A, it is selected by the user through the key 708 on the operation screen of FIG. 6B to add the margin, the size of the original corresponding to the output image is “A5R” (this parameter is based on the original size input data obtained through the operation unit or the original size information obtained from the original size sensor of the reader unit 1), the size of the recording paper on which the image is formed is “A3” (this parameter is based on the output paper size input data obtained through the operation unit or the output paper size information obtained from the recording paper size sensor provided in the paper feed cassette of the printer unit 2), the process “sub scan direction (lateral direction)=twice” is set through the key 702, 703 or 704 on the operation screen of FIG. 6B, and the process “main scan direction (longitudinal direction)=twice” is set through the key 705, 706 or 707 on the operation screen of FIG. 6B.

In the present embodiment, because the A5R size is 210 mm×148.5 mm and the margin is 2.5 mm, the image to which the margin has been added is as shown in FIG. 7D, and the image size actually subjected to the image repeat function is 210 mm×148.5 mm being the same as the original size. Then, if it is assumed that the image is formed based on 600 dpi, the above size is represented as 4960 dots×3507 dots.

In this case, after the original was read, it is controlled by the control unit (i.e., the CPU 122) to store the image data (FIG. 7D) of 4960 dots×3507 dots obtained by masking the margin with assistance of the patterning/fattening/masking/trimming circuit 117 of FIG. 1 in any one of the plural storage memories 1 (5001) to 100 (5100).

Then, it is controlled by the control unit to write the image data (FIG. 7D) on the storage memory by 4960 dots×3507 dots from the address (0, 0) on the layout memory 5000, write the image data by 4960 dots×3507 dots from the address (0, 3507), write the image data by 4960 dots×3507 dots from the address (4960, 0), and write the image data by 4960 dots×3507 dots from the address (4960, 3389). Thus, the image data shown in FIG. 7E is formed on the layout memory 5000, the formed image data is read and transferred to the printer unit 2, and the transferred image data is printed, whereby the image as shown in FIG. 7E is formed on the A3 recording paper.

As just described, when it is selected by the user to add the margin in the image repeat function, that is, when the first layout process is instructed, the control unit (i.e., the CPU 122) causes the printer unit 2 to perform the printing so that the plural same images (the images themselves correspond to the input images of one page) which are arranged in the horizontal direction on the same face of the one recording paper and of which the number corresponds to the number set based on the user's operation and the plural same images (corresponding to the same images as above) which are arranged in the vertical direction on the same face of the one recording paper and of which the number corresponds to the number set based on the user's operation are arranged and formed in the respective directions with the margin (that is, by separating the images at the predetermined interval).

Incidentally, the printing is the example of the output process in the present embodiment. That is, it is possible to perform, as the output process, the transmission process for transmitting the layout-processed image data to an external apparatus, and the display process for causing the display unit to preview-display the layout-processed image.

Hereinafter, the image repeat operation in the image forming apparatus according to the present invention will be explained with reference to a flow chart shown in FIG. 8.

That is, FIG. 8 is the flow chart showing an example of a first control processing procedure in the image forming apparatus according to the present invention, and the first control processing procedure corresponds to the image repeat operation. Here, it is assumed that the process of the flow chart of FIG. 8 is entirely performed by the CPU 122 acting as the control unit of FIG. 2 in the present embodiment on the basis of the program stored in the ROM 124 or another storage medium. Incidentally, symbols S9-1 to S9-12 denote respective steps.

In a case where various settings (selections of various functions, setting of an image forming mode, detailed setting of the image forming mode, and the like) are performed by the user through the operation unit 123 selectively displaying the various operation screens including the operation screens of FIGS. 3A to 3C and the operation screens of FIGS. 6A to 6E and it is instructed to start the copying through the start key 241 of the operation unit shown in FIG. 3A, it is judged in the step S9-1 by the CPU 122 whether or not the image repeat mode is being set. That is, it is judged whether or not the key 701 on the operation screen of FIG. 6A is depressed. When it is judged that the image repeat mode is not set (the key 701 is OFF), the flow advances to the step S9-12 to perform ordinary copying and then end the process.

On one hand, when it is judged in the step S9-1 that the image repeat mode is being set (the key 701 is ON), the flow advances to the step S9-2 to further judge whether or not the image repeat mode should be executed with the margin added. More specifically, it is judged whether or not it is selected by the user to add the margin through the key 708 on the operation screen of FIG. 6B displayed on the display unit 250 by the CPU 122 in response to the depression of the key 701 on the operation screen of FIG. 6A.

When it is judged in the step S9-2 that the image repeat mode should be executed with the margin added, that is, when it is selected by the user through the key 708 to add the margin (in this case, “YES” is checked by the key 708 on the operation screen of FIG. 6D), the flow advances to the step S9-3 to calculate the image size with the margin added (i.e., the size of the image repeated with the margin added (FIG. 7D)). Here, it is assumed that the original size used to calculate the image size has already been detected based on the information obtained from the original size sensor in a not-shown pre-scanning step performed by the reader unit 1 prior to the step S9-1. However, the original size may be set by the user through the operation unit 123. Besides, when the image process such as the trimming or the like has been set through the operation unit 123, the image size after the trimming was performed is used as the original size to calculate the image size with the margin added. Moreover, when a magnification change (enlargement/reduction) or the like has been set through the operation unit 123, the image size after the magnification change was performed is used as the original size to calculate the image size with the margin added.

On one hand, when it is judged in the step S9-2 that the image repeat mode should be executed without the margin, that is, when it is selected by the user through the key 708 not to add the margin (in this case, “NON” is checked on the operation screens of FIGS. 6C and 6E), the flow advances to the step S9-4 to calculate the image size from which the margin has been eliminated (i.e., the size of the image to be repeated from which the margin has been eliminated (FIG. 7B)). Here, likewise, it is assumed that the original size used to calculate the image size has already been detected in the not-shown pre-scanning step performed by the reader unit 1 prior to the step S9-1. However, the original size may be set by the user through the operation unit 123. Besides, when the image process such as the trimming or the like has been set, the image size after the trimming was performed is used as the original size to calculate the image size from which the margin has been eliminated. Moreover, when the magnification change (enlargement/reduction) or the like has been set, the image size after the magnification change was performed is used as the original size to calculate the image size from which the margin has been eliminated.

Next, it is judged in the step S9-5 whether or not the number of repeats in either one of the main scan direction (corresponding to the longitudinal direction and the first direction) and the sub scan direction (corresponding to the lateral direction and the second direction) is “AUTO”. Here, it should be noted that, in the case where the number of repeats is “AUTO”, the number of the same images to be arranged and formed on the same face of the one recording paper in the image repeat mode is automatically determined under the control of the CPU 122 on the basis of judgment materials such as an original size, a recording paper size and the like. Incidentally, the judgment in the step S9-5 is performed by checking with the CPU 122 whether an instruction to automatically determine the number of image repeats is input by the user through either one of the keys 704 and 707 on the operation screen of FIG. 6B or the number of image repeats is manually set by the user through any one of the keys 702, 703, 705 and 706 on the operation screen of FIG. 6B.

When it is judged in the step S9-5 that the number of repeats in both the longitudinal direction and the lateral direction is not “AUTO”, that is, when the instruction to automatically determine the number of image repeats in the lateral direction is not input by the user through the key 704 and the instruction to automatically determine the number of image repeats in the longitudinal direction is not input by the user through the key 707, the flow advances to the step S9-8. In this step, the entire image size (FIG. 7C or FIG. 7E) after the image repeat operation was performed is calculated from the image size calculated in the step S9-3 or S9-4 (i.e., the image size corresponding to A5R in the example of FIGS. 7A to 7E) and the number of repeats, and then it is judged whether or not repeat recording of the entire image (FIG. 7B or FIG. 7D) corresponding to the set number of repeats can be performed on the selected recording paper. Here, it should be noted that the number of repeats in this case is determined based on the number of image repeats in the lateral direction manually set by the user through either one of the keys 702 and 703 and the number of image repeats in the longitudinal direction manually set by the user through either one of the keys 705 and 706. In the example of FIGS. 7A to 7E, the number of image repeats in the lateral direction is two and the number of image repeats in the longitudinal direction is also two, whereby the number of image repeats is totally four with respect to each output paper. Then, when it is judged in the step S9-8 that the repeat recording of the entire image can be performed on the selected recording paper, the flow advances to the step S9-11.

On one hand, when it is judged in the step S9-8 that the repeat recording of the entire image (FIG. 7B or FIG. 7D) corresponding to the set number of repeats cannot be performed on the selected recording paper, the flow advances to the step S9-10 to calculate the image size of one time from which the repeat recording corresponding to the set number of repeats can be performed in both the main scan direction and the sub scan direction on the selected recording paper. After then, the flow further advances to the step S9-11.

Incidentally, when it is judged in the step S9-5 that the number of repeats in either one of the main scan direction and the sub scan direction is “AUTO”, that is, when it is instructed by the user to automatically set only the number of image repeats in either one of the lateral direction and the longitudinal direction through either one of the keys 704 and 707, the flow advances to the step S9-6 to calculate the number of repeats in the direction to which the number of repeats has been set to “AUTO”, on the basis of the image size calculated in the step S9-3 or S9-4 and the selected recording paper size.

Next, in the step S9-7, the entire image size (FIG. 7C or FIG. 7E) after the image repeat operation was performed is calculated from the image size calculated in the step S9-3 or S9-4 and the number of repeats, and then it is judged whether or not the repeat recording of the entire image (FIG. 7B or FIG. 7D) corresponding to the set number of repeats can be performed on the selected recording paper. Here, when it is judged that the repeat recording of the entire image can be performed on the selected recording paper, the flow advances to the step S9-11.

On the contrary, when it is judged in the step S9-7 that the repeat recording of the entire image (FIG. 7B or FIG. 7D) corresponding to the set number of repeats cannot be performed on the selected recording paper, the flow advances to the step S9-9 to calculate the image size of one time from which the repeat recording corresponding to the set number of repeats can be performed in both the main scan direction and the sub scan direction on the selected recording paper. After then, the flow further advances to the step S9-11.

Next, in the step S9-11, the image repeat copying operation is performed, and the process ends. More specifically, the image data is first read from the original and processed under the control of the CPU 122. That is, the masking is performed to the margin when it is selected to add the margin, the trimming is performed to eliminate the margin when it is selected not to add the margin, and the trimming is performed with the calculated image size when the image size in question is calculated in the step S9-9 or S9-10. Then, the processed image data is stored on the storage memory, the stored image data is then read and written on the layout memory 5000 by the number corresponding to the set or calculated number of repeats in the main scan direction and the sub scan direction, as shown in FIGS. 7A to 7D, and the image data laid out on the layout memory 5000 are transferred to the printer unit 2. After then, the transferred image data is printed, and the process ends.

Hereinafter, examples 1 to 3 in case of executing the image repeat function will be described.

### Example 1

Hereinafter, it will be explained with reference to FIG. 8 the process which is to be performed under the control of the CPU 122 in a case where the copying is started by depressing the start key 241 on the premise that the image repeat mode is set by the user through the operation unit 123 (that is, the image repeat mode is selected by the key 701 on the operation screen of FIG. 6A), it is set to add the margin (that is, “YES” is checked by the key 708 on the operation screen of FIG. 6B), the number of repeats in the main scan direction is set to “2” (that is, the process “main scan direction (longitudinal direction)=twice” is set by the keys 705 and 706 on the operation screen of FIG. 6B), the number of repeats in the sub scan direction is set to “2” (that is, the process “sub scan direction (lateral direction)=twice” is set by the keys 702 and 703 on the operation screen of FIG. 6B), the A4 original is set (that is, the original size is set by a not-shown original size key), and the A3 recording paper is set (that is, the output paper size of A3 is set by the key 252 on the operation screen of FIG. 3A).

It is judged in the step S9-1 whether or not the image repeat mode is being set. Then, because the image repeat mode is being set, the flow advances to the step S9-2 to further judge whether or not the image repeat mode should be executed with the margin added. Subsequently, because the image repeat mode should be executed with the margin added, the flow advances to the step S9-3 to calculate the image size with the margin added (or the margin-added image size). Here, because it is set to add the margin, the image size actually repeated is A4 (lateral) 210 mm in the sub scan direction and A4 (longitudinal) 297 mm in the main scan direction.

Then, the flow advances to the step S9-5 to judge whether or not the number of repeats is “AUTO”. In this case, because the number of repeats is not “AUTO” (that is, the processes “main scan direction (longitudinal direction)=twice” and “sub scan direction (lateral direction)=twice” are set, the flow advances to the step S9-8 to judge whether or not the repeat recording of the entire image corresponding to the set number of repeats can be performed.

Here, because the size of the image to be repeated is “210 mm×repeat number 2=420 mm” in the sub scan direction and “297 mm×repeat number 2=594 mm” in the main scan direction on the basis of the image size calculated in the step S9-3, the repeat recording of the entire image “210 mm×297 mm” corresponding to the set number of repeats cannot be performed on the A3 recording paper “420 mm×297 mm”.

Thus, the flow advances to the step S9-10 to calculate the image size of one-time repeat which can be repeated the number of times corresponding to the set number of repeats. Here, the image size “420 mm” in the sub scan direction can be recorded on the recording paper, but the image size “594 mm” in the main scan direction cannot be recorded on the recording paper. Thus, the original image size “594 mm” in the main scan direction is divided by the recording paper size “297 mm” in the main scan direction, so that “594 mm/297 mm=2” is obtained. As a result, ½ of the former image (A4 size) in the main scan direction is set as the repeat target image. That is, the image of “297 mm/2=148.5 mm” in the main scan direction is repeated.

After then, the flow advances to the step S9-11. In the step S9-11, the image data of the A4 original is read, the trimming is performed to the read image data in conformity with the image size calculated in the step S9-10, the masking is performed to the margin, and the obtained image data is stored on the storage memory. Subsequently, the stored image data of the size “210 mm in the sub scan direction×148.5 mm in the main scan direction” is repeatedly printed twice in the sub scan direction and twice in the main scan direction on the same face of the A4 recording paper, and then the process ends. Thus, it is possible to obtain the output result as shown in FIG. 7E that the margin is added to each of the image in the longitudinal direction and the image in the lateral direction. Incidentally, it should be noted that the image size in this case is different from those shown in FIGS. 7A to 7E.

### Example 2

Hereinafter, it will be explained with reference to FIG. 8 the process which is to be performed under the control of the CPU 122 in a case where the copying is started by depressing the start key 241 on the premise that the image repeat mode is set by the user through the operation unit 123 (that is, the image repeat mode is selected by the key 701 on the operation screen of FIG. 6A), it is set not to add the margin (that is, “NON” is checked by the key 708 on the operation screen of FIG. 6B), the number of repeats in the main scan direction is set to “2” (that is, the process “main scan direction (longitudinal direction)=twice” is set by the keys 705 and 706 on the operation screen of FIG. 6B), the number of repeats in the sub scan direction is set to “2” (that is, the process “sub scan direction (lateral direction)=twice” is set by the keys 702 and 703 on the operation screen of FIG. 6B), the A4 original is set (that is, the original size is set by the not-shown original size key), and the A3 recording paper is set (that is, the output paper size of A3 is set by the key 252 on the operation screen of FIG. 3A).

It is judged in the step S9-1 whether or not the image repeat mode is being set. Then, because the image repeat mode is being set, the flow advances to the step S9-2 to further judge whether or not the image repeat mode should be executed with the margin added. Subsequently, because the image repeat mode should be executed without the margin, the flow advances to the step S9-4 to calculate the image size without the margin (i.e., the margin-eliminated image size). Here, the interval corresponding to the margin is 2.5 mm. Then, because it is set not to add the margin, the image size actually repeated is A4 (lateral) 210 mm-2.5 mm×2=205 mm in the sub scan direction and A4 (longitudinal) 297 mm-2.5 mm×2=292 mm in the main scan direction.

Then, the flow advances to the step S9-5 to judge whether or not the number of repeats is “AUTO”. In this case, because the number of repeats is not “AUTO” (that is, the processes “main scan direction (longitudinal direction)=twice” and “sub scan direction (lateral direction)=twice” are set), the flow advances to the step S9-8 to judge whether or not the repeat recording of the entire image corresponding to the set number of repeats can be performed.

Here, because the size of the image to be repeated is “205 mm×repeat number 2=410 mm” in the sub scan direction and “292 mm×repeat number 2=548 mm” in the main scan direction on the basis of the image size calculated in the step S9-4, the repeat recording of the entire image “205 mm×292 mm” corresponding to the set number of repeats cannot be performed on the A3 recording paper “420 mm×297 mm”.

Thus, the flow advances to the step S9-10 to calculate the image size of one-time repeat which can be repeated the number of times corresponding to the set number of repeats. Here, the image size “410 mm” in the sub scan direction can be recorded on the recording paper, but the image size “584 mm” in the main scan direction cannot be recorded on the recording paper. Thus, the original image size “584 mm” in the main scan direction is divided by the recording paper size “297 mm” in the main scan direction, so that “2” is obtained. As a result, ½ of the former image in the main scan direction is set as the repeat target image. That is, the image of “292 mm/2=146 mm” in the main scan direction is repeated.

After then, the flow advances to the step S9-11. In the step S9-11, the image data of the A4 original is read, the trimming is performed to the read image data in conformity with the image size calculated in the step S9-10 (here, the trimming is performed also in consideration of elimination of the margin), and the obtained image data is stored on the storage memory. Subsequently, the stored image data of the size “205 mm in the sub scan direction×146 mm in the main scan direction” is repeatedly printed twice in the sub scan direction and twice in the main scan direction, and then the process ends. Thus, it is possible to obtain the output result as shown in FIG. 7C that the margin is not added to each of the image in the longitudinal direction and the image in the lateral direction. Incidentally, it should be noted that the image size in this case is different from those shown in FIGS. 7A to 7E.

### Example 3

Hereinafter, it will be explained with reference to FIG. 8 the process which is to be performed under the control of the CPU 122 in a case where the copying is started by depressing the start key 241 on the premise that the image repeat mode is set by the user through the operation unit 123 (that is, the image repeat mode is selected by the key 701 on the operation screen of FIG. 6A), it is set not to add the margin (that is, “NON” is checked by the key 708 on the operation screen of FIG. 6B), the number of repeats in the sub scan direction is set to “AUTO” (that is, “AUTO” is set by the key 704 on the operation screen of FIG. 6B), the number of repeats in the main scan direction is set to “AUTO” (that is, “AUTO” is set by the key 707 on the operation screen of FIG. 6B), the A5R original is set (that is, the original size A5R is set by the not-shown original size key), and the A3 recording paper is set (that is, the output paper size of A3 is set by the key 252 on the operation screen of FIG. 3A).

It is judged in the step S9-1 whether or not the image repeat mode is being set. Then, because the image repeat mode is being set, the flow advances to the step S9-2 to further judge whether or not the image repeat mode should be executed with the margin added. Subsequently, because the image repeat mode should be executed without the margin, the flow advances to the step S9-4 to calculate the image size without the margin. Then, because it is set not to add the margin, the image size actually repeated is A5R (lateral) 210 mm-2.5 mm×2=205 mm in the sub scan direction and A5R (longitudinal) 148.5 mm-2.5 mm×2=143.5 mm in the main scan direction.

Then, the flow advances to the step S9-5 to judge whether or not the number of repeats is “AUTO”. In this case, because the number of repeats is “AUTO” (that is, the number of times of repeat “AUTO” in the sub scan direction and the number of times of repeat “AUTO” in the main scan direction are set), the flow advances to the step S9-6 to judge the number of times of repeat. Here, because the length of the recording paper in the sub scan direction is “420 mm” and the length of the image to be repeated is “205 mm”, the number of times of repeat in the sub scan direction is obtained as “2” (that is, “420 mm” is divided by “210 mm”). Likewise, because the length of the recording paper in the main scan direction is “297 mm” and the length of the image to be repeated is “143.5 mm” in the main scan direction, the number of times of repeat in the main scan direction is obtained as “2” (that is, “297 mm” is divided by “143.5 mm”).

Then, the flow advances to the step S9-7 to judge whether or not the repeat recording of the entire image corresponding to the set number of times of repeat can be performed on the selected recording paper.

Here, because the size of the image to be repeated is “205 mm×repeat number 2=410 mm” in the sub scan direction and “143.5 mm×repeat number 2=287 mm” in the main scan direction on the basis of the image size calculated in the step S9-4, the repeat recording of the entire image “205 mm×143.5 mm” corresponding to the set number of times of repeat can be performed on the A3 recording paper “420 mm×297 mm”.

Thus, the flow advances to the step S9-11. In the step S9-11, the image data of the A5R original is read, the trimming is performed to the read image data so as to eliminate the margin, and the obtained image data is stored on the storage memory. Subsequently, the stored image data of the size “205 mm in the sub scan direction×143.5 mm in the main scan direction” is repeatedly printed twice in the sub scan direction and twice in the main scan direction, and then the process ends. Thus, it is possible to obtain the output result as shown in FIG. 7C that the margin is not added to each of the image in the longitudinal direction and the image in the lateral direction.

As described above, in the image forming apparatus according to the present embodiment, the two modes, i.e., the mode to add the margin and the mode not to add the margin, are provided in the image repeat function. Thus, when it is selected by the user to add the margin in the image repeat function, it is controlled by the CPU 122 to add the margin to the image-repeat image, whereby the cutout margin is provided. Thus, it is possible to cut out the recording paper along the cutout margin, whereby the image repeat result can be obtained without considering some image shift or aberration. On one hand, in consideration of the uses who wish to output the image-repeat image in which the plural same images are closed up without margin, it is controlled by the CPU 122 to enable the image repeat output that the image intervals are closed up without margin when it is selected by the user not to add the margin in the image repeat function.

As just described, in the present embodiment, both the function to perform the image repeat operation with the margin added and the function to perform the image repeat operation without the margin are provided, either one of the two functions is selected and set by the user with use of the key 708, and it is controlled by the CPU 122 based on the set result whether or not to add the margin, whereby the various kinds of user's needs can be satisfied. In addition, because the display operation of the operation unit 123 including the display unit 250 is controlled by the CPU 122, it is possible to provide the convenient user interface as shown in FIGS. 6A to 6E, and it is thus possible to increase the user's operability even when the two kinds of modes are provided in the image repeat function, whereby it enables the user to easily understand and utilize the two kinds of modes.

### Second Embodiment

In the above first embodiment, the one-time image data (FIGS. 7B and 7D) read by the reader unit 1 and subjected to the trimming and the masking according to the presence/absence of margin is once stored in the storage memory, the stored one-time image data is then repeatedly written on the layout memory 5000 the set number of times of repeat in the main scan direction and the sub scan direction, thereby achieving the image repeat function. On one hand, in the present embodiment, the following operation is performed to achieve the image repeat function.

That is, in the present embodiment, the data of the same line in the main scan direction are continuously output plural times corresponding to the number of times of repeat in the main scan direction (i.e., the number of times in the main scan direction based on user's setting on the operation unit), the image data repeated in the main scan direction are stored in the storage memory, and the image data repeated in the main scan direction and stored on the storage memory are written on the layout memory 5000 plural times corresponding to the number of times of repeat in the sub scan direction, thereby achieving the image repeat function.

### Third Embodiment

In the present embodiment, another magnification change/repeat circuit is provided immediately before an image memory 120. Hereinafter, the present embodiment will be explained.

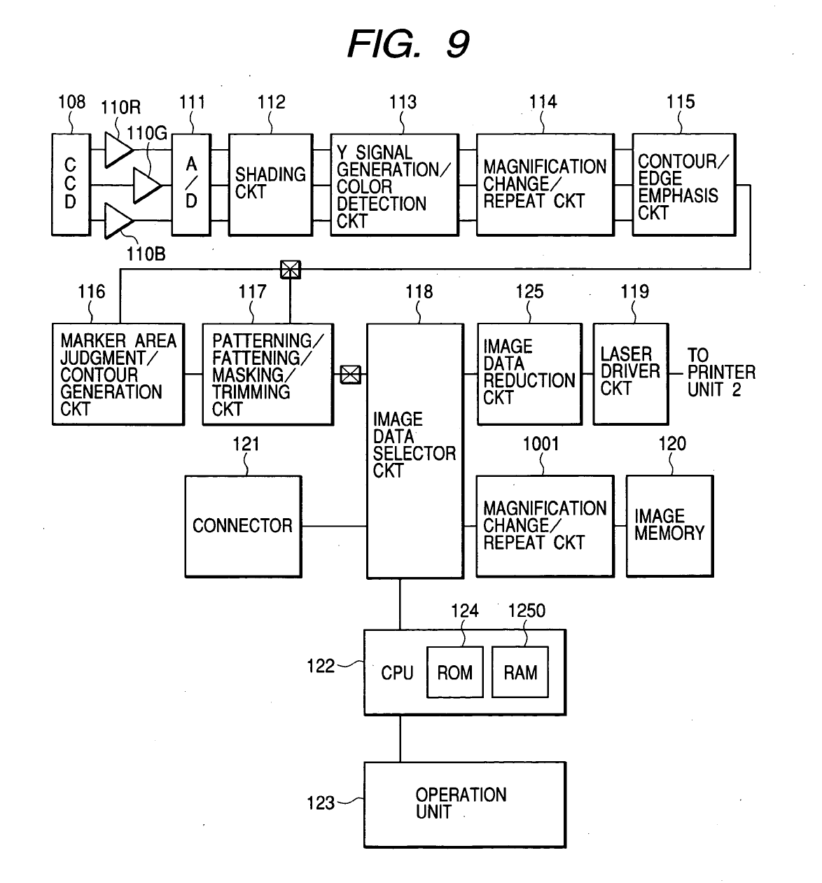

FIG. 9 is a circuit block diagram showing signal processes of a reader unit 1 in the image forming apparatus according to the third embodiment of the present invention. In FIG. 9, it should be noted that the same parts as those shown in FIG. 2 are respectively denoted by the same numerals as those shown in FIG. 2.

In FIG. 9, numeral 1001 denotes a magnification change/repeat circuit which can output the plural same images read by the image memory 120.

In the present embodiment, a magnification change/repeat circuit 114 continuously outputs the data on the same line in the main scan direction by the number of times of repeat in the main scan direction, and then stores the image data repeated in the main scan direction on the storage memory in the image memory 120. Subsequently, when the image data repeated in the main scan direction and stored are read, the stored image data are continuously output repeatedly by plural times corresponding to the number of times of repeat in the sub scan direction by the magnification change/repeat circuit 1001, and the output image data are then transferred to the printer unit 2, whereby the image repeat function can be achieved without performing layout of the image data on a layout memory 5000.

### Fourth Embodiment

In the above first to third embodiments, the original image is read by the reader unit 1, and the read image data is then processed by executing the image repeat function. On one hand, it is possible to perform the image repeat output by repeating the image data input from an external apparatus (e.g., a personal computer) through the connector 121 by plural times corresponding to the number of times of repeat in the main scan direction and the sub scan direction on the layout memory 5000.

In this case, the image repeat settings as shown in FIGS. 6B to 6E are performed on the printer driver of the external apparatus (e.g., the personal computer), and the processes in the steps S9-1 to S9-10 of FIG. 8 are performed by the printer driver in question. After then, one-time image data (i.e., the image data having an image size when the image size in question is calculated in the steps S9-9 and S9-10) generated according to settings of margin presence/absence, the set number of times of repeat in the main scan direction, the set number of times of repeat in the sub scan direction, a recording paper size, and processing condition data commands such as an image repeat print command and the like are transmitted from the external apparatus. When the commands in question are received, it is controlled by the CPU 122 to perform the image repeat process according to the received commands to the image data received together with the commands in question.

Then, the image forming apparatus achieves the image repeat printing by receiving the image data transmitted from the external apparatus through the connector 121, storing the received image data of one page of the original being the image repeat target on the storage memory provided in the image memory 120, writing the stored one-page image data on the layout memory 5000 by plural times corresponding to the number of times of repeat in the main scan direction and the number of times of repeat in the sub scan direction (that is, in the example of FIGS. 7A to 7E, the two same images are arranged and formed in each of the longitudinal direction and the lateral direction), and then recording the image data laid out on the layout memory 5000 onto a recording paper.

Besides, it is also possible to set the image repeat function as shown in FIGS. 6B to 6E on the personal computer side through the printer driver of the personal computer (i.e., the external apparatus such as a host computer or the like), perform the processes in the steps of the flow chart shown in FIG. 8 by using the personal computer, perform the image repeat operation of the image data (either the data read by a scanner or the like or the data generated through various applications) on the memory of the personal computer, generate the image repeat image data having a margin or no margin, and cause the image forming apparatus to print the image data subjected to the image repeat process.

As just described, it is possible to cause the host computer side to perform the image repeat process of the present embodiment through the printer driver, transmit the image data subjected to the image repeat process from the host computer to the image forming apparatus, receive the transmitted image data subjected to the image repeat process, and cause the printer unit 2 to print the received image data as it is under the control of the CPU 122, thereby obtaining the output results as shown in FIGS. 7A to 7E. Besides, as previously described, it is possible to perform the actual image repeat process of the present embodiment on the image forming apparatus side to which the image data was transmitted from the host computer. Even in a case where the image repeat process is performed on the host computer side and then the image forming is performed on the image forming apparatus side, or even in a case where the image repeat process is not performed on the host computer side but performed on the image forming apparatus side, it only has to be able to selectively output the final output results as shown in FIGS. 7A to 7E in accordance with the user's instruction through the key 708 on the operation screen of FIG. 6B.

As explained above, it is possible to obtain the image with the margin (cutout margin) added in the image repeat function, the user can cut out the recording paper along the obtained cutout margin. As a result, it is possible to make the image shift or aberration in the image cutout operation due to some image shift or aberration in the printing operation obscure, whereby it is possible to easily satisfy the user's needs in the image cutout operation without considering device adjustments, environments and the like.

Moreover, the setting function to enable the display unit to display the operation screen including the key 708 and also enable the user to select and set whether or not to use the above margin adding function through the key 708 is provided, whereby it is possible to satisfy the conventional and new user's needs concerning the output result in which the intervals between the adjacent images are closed up for the purpose of usages as a background, a pattern and the like, that is, it is possible to provide flexible image repeat environments which satisfy the user's needs.

Furthermore, when it is instructed by the user through the key 704 or 707 to automatically set the number of times of repeat, the CPU 122 enables to calculate the number of times, whereby the repeat operation can be achieved even if the user does not input the number of times of repeat through the key 702, 703, 705 or 706. Besides, in a case where the user does not satisfy the calculated result, he can adjust and correct it by manually inputting the number of times of repeat through the key 702, 703, 705 or 706.

Incidentally, in FIG. 1, the case where the printer unit (i.e., the printer engine) adopts a laser beam system is explained by way of example. However, the present invention is applicable also to another printing system such as an electrophotographic system (e.g., an LED system), a liquid crystal shutter system, an inkjet system, a thermal-transfer system, a dye sublimation system, or the like.

Moreover, it should be noted that the structure which is obtained by combining the structures in the above first to fourth embodiments is also included in the present invention.

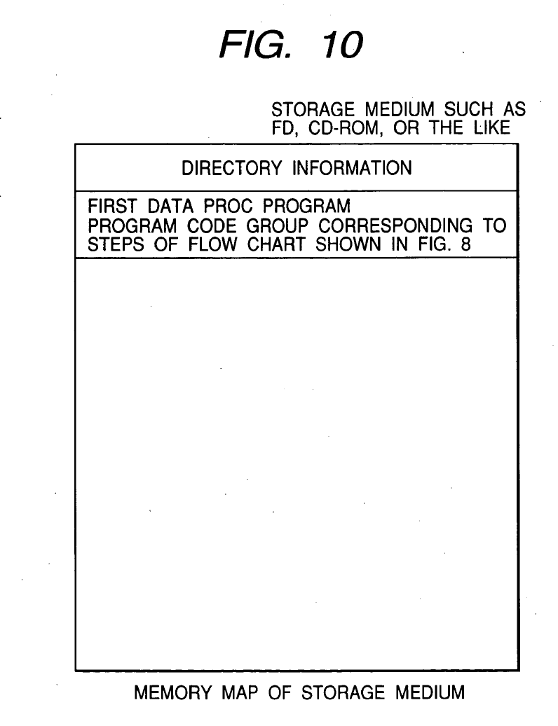

Hereinafter, the structure of a data processing program which can be read by the image forming apparatus according to the present invention will be explained with reference to a memory map shown in FIG. 10.

That is, FIG. 10 is the diagram for explaining the memory map of the storage medium which stores the various data processing programs capable of being read by the image forming apparatus according to the present invention.

Incidentally, though it is not illustrated specifically, information (including version information, creator information, etc.) for administrating the program groups stored in the storage medium is also stored in the storage medium, and information (including icon information for discriminatively displaying a program, etc.) depending on an OS or the like on the program reading side is occasionally stored in the storage medium.

Moreover, the data depending on the various programs are administrated by a directory. Besides, programs or the like to uncompress installed programs and data are occasionally stored when the installed programs and data have been compressed.

Moreover, the functions of the present embodiment shown in FIG. 8 may be executed by the host computer based on externally installed programs. In this case, the present invention is applicable even in a case where an information group including programs is supplied from a storage medium (such as a CD-ROM, a flash memory, or an FD) or an external storage medium through a network to an output apparatus.

Moreover, it is needless to say that the object of the present invention can be achieved in a case where the storage medium storing the program codes of software to realize the functions of the above embodiments is supplied to a system or an apparatus and then a computer (or CPU or MPU) in the system or the apparatus reads and executes the program codes stored in the storage medium.

In this case, the program codes themselves read from the storage medium realize the new functions of the present invention, whereby the storage medium storing these program codes constitutes the present invention.

As the storage medium for supplying the program codes, for example, a flexible disk, a hard disk, an optical disk, a magnetooptical disk, a CR-ROM, a CR-R, a DVD-ROM, a magnetic tape, a nonvolatile memory card, a ROM, an EEPROM, a silicon disk or the like can be used.

Moreover, it is needless to say that the present invention includes not only a case where the functions of the above embodiments are realized by executing the program codes read by the computer, but also a case where an OS (operating system) or the like functioning on the computer executes a part or all of the actual process according to instructions of the program codes, whereby the functions of the above embodiments are achieved by that process.

Furthermore, it is needless to say that the functions of the above embodiments can be achieved in a case where the program read from the storage medium is once written in a memory provided in a function expansion board inserted in the computer or a function expansion unit connected to the computer, and then a CPU or the like provided in the function expansion board or the function expansion unit executes a part or all of the actual process according to the instructions of the program.

Furthermore, the present invention may be applied to a system consisting of plural apparatuses or to a single-body apparatus. Besides, it is needless to say that the present invention is applicable to a case where the program is supplied to the system or the apparatus to achieve the functions of the above embodiments. In this case, when the storage medium which stores the programs represented by software to achieve the above embodiments of the present invention is read by the system or the apparatus, the system or the apparatus in question can obtain the effects of the present invention.

Furthermore, when the program represented by software to achieve the present invention is downloaded and read from a database on a network according to a communication program, the system or the apparatus in question can obtain the effects of the present invention.

As explained above, according to the present embodiment, because the margin adding function to add the margin between the adjacent two of the plural formed images is provided in the image repeat process to repeatedly form a part or all of the image data on the one recording paper plural times, it is possible to output the image with the margin (cutout margin) added in the image repeat function. Thus, when the plural images are printed on the one recording paper for the purpose of cutout operation in the image repeat function, the user can easily cut out the recording paper along the above cutout margin. As a result, it is possible to make the image shift or aberration in the image cutout operation due to some image shift or aberration in the printing operation obscure, whereby it is possible to easily satisfy the user's needs in the image cutout operation without considering device adjustments, environments and the like.

Moreover, because the setting function to enable the user to select and set whether or not to use the margin adding function is provided, it is possible to easily satisfy the conventional and new user's needs concerning the output result in which the intervals between the adjacent images are closed up for the purpose of usages as the background, the pattern and the like, that is, it is possible to provide the flexible image repeat environments which satisfy the user's needs.

Furthermore, because it enables to calculate the number of times of repeat, the repeat operation can be achieved even if the user does not input the number of times of repeat. Besides, in a case where the user does not satisfy the calculated result, he can adjust and correct it by manually inputting the number of times of repeat.

Therefore, it is possible to provide the flexible image repeat environments capable of easily satisfying the new user's needs concerning the use of the image repeat function for the purpose of obtaining the image considering the cutout operation and the conventional user's needs concerning the use of the image repeat function for the purpose of obtaining the image to be used as the background, the pattern and the like.

In addition, it is possible to provide the flexible image repeat environments capable of coping with the various user's needs in consideration of the operability, the usability for the user, and the like.

1-27. (canceled)

28. An image forming apparatus which has an image repeat function capable of arranging images repeatedly on a same face of one recording sheet, comprising:
a receiving unit configured to receive, from a user, a length of a margin with an image; and
a controller configured to arrange the images repeatedly with the margin of the length received by the receiving unit.

29. An image forming apparatus according to claim 28, wherein the receiving unit receives the length of the margin by a numerical value.

30. An image forming apparatus according to claim 28, further comprising:
an accepting unit configured to accept, from a user, a number of the images repeatedly arranged,
wherein the controller arranges the images of the number accepted by the accepting unit.

31. An image forming apparatus according to claim 28, wherein the margin is made around the image.

32. An image forming apparatus according to claim 28, wherein the image forming apparatus is capable of arranging the images based on either one of data sent from a scanner and data sent from a computer.

33. A control method for controlling an image forming apparatus which has an image repeat function capable of arranging images repeatedly on a same face of one recording sheet, comprising:
a receiving step of receiving, from a user, a length of a margin with an image; and
a control step of arranging the images repeatedly with the margin of the length received in the receiving step.

34. A non-transitory computer readable storage medium for storing a computer program for controlling an image forming apparatus which has an image repeat function capable of arranging images repeatedly on a same face of one recording sheet, the computer program comprising:
a code to receive, from a user, a length of a margin with an image; and
a code to arrange the images repeatedly with the margin of the received length.
